(19) United States
(12) Patent Application Publication
(10) Pub. No.: US 2024/0014892 A1
(43) Pub. Date: Jan. 11, 2024

(54) MITIGATION OF INTERFERENCE FROM SUPPLEMENTAL COVERAGE FROM SPACE (SCS) NETWORKING

(71) Applicants: Stephen T. Palermo, Chandler, AZ (US); Valerie J' Parker, Portland, OR (US)

(72) Inventors: Stephen T. Palermo, Chandler, AZ (US); Valerie J' Parker, Portland, OR (US)

(21) Appl. No.: 18/373,035

(22) Filed: Sep. 26, 2023

Related U.S. Application Data
(60) Provisional application No. 63/521,522, filed on Jun. 16, 2023.

(51) Int. Cl. H04B 7/185

(52) U.S. Cl. CPC H04B 7/18513; H04B 7/18519

(57) ABSTRACT

Various approaches for detecting and mitigating interference in a supplemental coverage from space (SCS) networking arrangement are disclosed, using an SCS zone for a geographic area in connection with exclusion, coordination, or inclusion of SCS communications in the geographic area. In an example, an approach for dynamically mitigating interference includes: obtaining orbital position data for at least one satellite vehicle (e.g., low-earth orbit (LEO) SV), which can perform SCS network communications to a geographic area that includes a terrestrial network (e.g., 5G network); determining operational parameters to mitigate terrestrial interference of the SCS network communications in the geographic area, with the geographic area identified based on the orbital position data; and modifying operation of the SCS network communications in the geographic area, based on the determined operational parameters.

### PRIORITY CLAIM

This application claims the benefit of priority to U.S. Provisional Patent Application No. 63/521,522, filed Jun. 16, 2023, and titled “MITIGATION OF INTERFERENCE FROM SUPPLEMENTAL COVERAGE FROM SPACE (SCS) NETWORKING”, which is incorporated herein by reference in its entirety.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates network connectivity in non-terrestrial (satellite) and terrestrial (e.g., mobile cellular network) settings, according to an example;

FIG. 2 illustrates a geographical map showing non-terrestrial network coverage and connectivity among various geographic areas, according to an example;

FIG. 3 illustrates a scenario of dynamic supplemental coverage from space (SCS) interference mitigation, according to an example.

FIG. 4 illustrates a flowchart of an example method of calculating dynamic SCS interference mitigation, according to an example.

FIG. 5 illustrates a flowchart of an example method of implementing dynamic SCS interference mitigation, according to an example.

FIG. 6 illustrates another scenario of geographic satellite connectivity from low-earth orbit satellite communication networks, according to an example;

FIGS. 7A and 7B illustrate terrestrial-based, LEO satellite-enabled edge processing arrangements, according to various examples;

FIG. 8 illustrates network uplink and downlinks including in an integrated-access backhaul (IAB) configuration of a non-terrestrial network, according to an example;

FIGS. 9A, 9B, and 9C illustrate respective configurations of non-terrestrial and 5G network architectures, according to various examples;

FIG. 10 illustrates an implementation of exclusion zones for a non-terrestrial communication network, according to an example;

FIG. 11 illustrates various types of exclusion zones implemented for a non-terrestrial communication network, according to an example;

FIG. 12 illustrates a flowchart of an example method of implementing exclusion zones for inter-satellite communications in a non-terrestrial communication network, according to an example;

FIGS. 13A and 13B illustrate views of an example interference scenario in inter-satellite communications of a non-terrestrial communication network according to an example;

FIGS. 14, 15A, 15B, 15C, and 15D illustrate tables of settings for establishing exclusion zones in a non-terrestrial communication network, according to various examples;

FIGS. 16A, 16B, 16C, and 16D illustrate further views of exclusion zones implemented by a non-terrestrial communication network, according to various examples;

FIG. 17 illustrates an overview of an edge cloud configuration for edge computing, according to an example;

FIG. 18 illustrates an overview of layers of distributed compute deployed among an edge computing system, according to an example;

FIG. 19 illustrates operational layers among endpoints, an edge cloud, and cloud computing environments;

FIG. 20 illustrates an example approach for networking and services in an edge computing system;

FIG. 21A illustrates an overview of example components deployed at a compute node system, according to an example;

FIG. 21B illustrates a further overview of example components within a computing device, according to an example; and

FIG. 22 illustrates a software distribution platform to distribute software instructions and derivatives, according to an example.

### DETAILED DESCRIPTION

The following discussion relates to various aspects of coordinating and adapting communications provided by non-terrestrial networks (NTNs), such as satellite low-earth orbit (LEO) networks. Specifically, the following extends the use of LEO “exclusion zone” concepts by considering measurements and network self-correction to use defined zones that mitigate in-band, cross-border, adjacent band, astronomy, and orbital debris interference concerns.

In various aspects of the following disclosure, measurements are used to adapt satellite communication networks that experience one or more of the following types of interference: terrestrial interference; satellite interference; cross-border interference; adjacent-band interference; and radio astronomy interference. These measurements are particularly relevant to possible interference occurring with “Supplemental Coverage from Space” or “SCS” deployments. SCS generally refers to the use of low-earth orbit (LEO) satellites by telecommunications providers to offer supplemental coverage of 5G or other cellular network radio communications from space to earth, such as in rural or sparsely populated areas without towers or wired network infrastructure.

The following zones that are calculated and changed dynamically—referred to herein as “SCS Zones”—can be used to address many technical aspects of interference and cooperation under debate now between on-ground communication service providers and satellite communication service providers. Among other settings, the following aspects may be used for compliance with United States Federal Communications Commission (FCC) interference regulations, such as 47 CFR 24.237(a) which requires coordination with “co-channel or adjacent channel incumbent fixed microwave licensees.” Similar concerns for interference relate to frequency restrictions, power and antenna height limits, light pollution, and interference protection generally.

The following discussion of SCS Zones incorporates the use of exclusion zone (“EZ”) and similar coordination zone (“CZ”) or inclusion zone (“IZ”) techniques in NTN networks to mitigate or reduce these and other regulatory and technical issues with SCS networking. A SCS Zone can enable a “site shield” for interference with SCS communications originating from space (or from ground stations), applicable in a variety of SCS coverage areas of a telecommunications operator.

The following also can be used to adapt Earth ground station RF transmit/receive operations, in earth-to-space, or space-to-earth communications, including for use by non-United States Earth stations, due to FCC regulatory requirements to provide same interference mitigations outside the United States. In further examples, these adaptive techniques may be used to adjust an SCS Zone to enable preemptive emergency call/911/distress access, or to provide enhancements applicable for mobile-satellite service, ground station service, and even integrated-access backhaul (IAB) service. These and other techniques are discussed in more detail after an introduction of non-terrestrial networks.

Overview of Non-Terrestrial Network Configurations

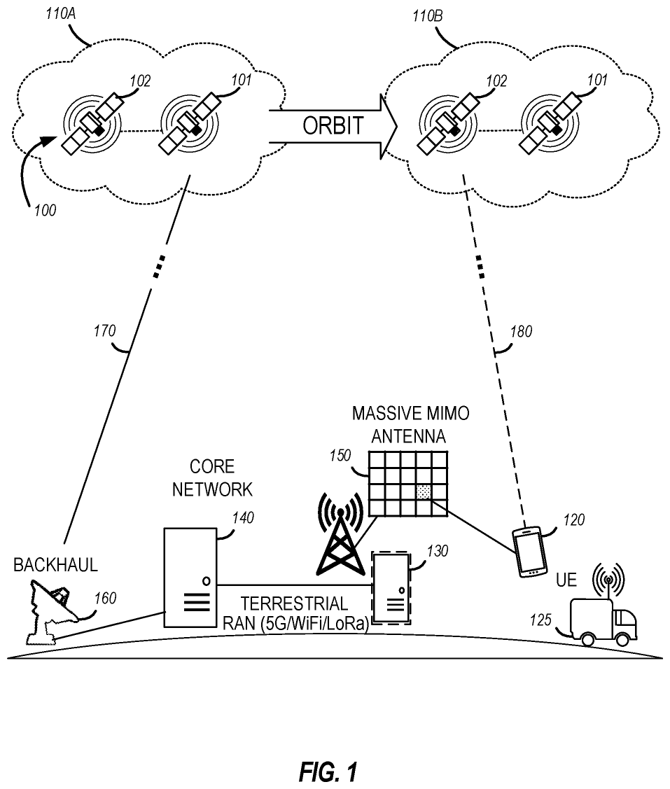

FIG. 1 illustrates network connectivity in non-terrestrial (satellite) and terrestrial (e.g., mobile cellular network) settings, according to an example. As shown, a satellite constellation 100 (the constellation depicted in FIG. 1 at orbital positions 110A and 110B) may include multiple satellite vehicles (SVs) 101, 102, which are connected to each other and to one or more terrestrial networks (TNs). The individual satellites in the constellation 100 (each, an SV) conduct an orbit around the Earth, at an orbit speed that increases as the SV is closer to Earth. LEO constellations are generally considered to include SVs that orbit at an altitude between 160 and 1000 km; at this altitude, each SV orbits the Earth about every 90 to 120 minutes.

The constellation 100 includes individual SVs 101, 102 (and numerous other SVs not shown), and uses multiple SVs to provide communications coverage to a geographic area on Earth. The constellation 100 may also coordinate with other satellite constellations (not shown), and with terrestrial-based networks, to selectively provide connectivity and services for individual devices (user equipment) or terrestrial network systems (network equipment). As used herein, a “geographic area” refers to an identifiable position, point, set or range of coordinates, location, region, or territory on, in, adjacent to, or above the Earth—including, in some examples, identifiable with reference to particular land or sea areas, or in airspace above the land or sea areas.

In this example, the satellite constellation 100 is connected via a satellite link 170 to a backhaul network 160, which is in turn connected to a 5G core network 140. The 5G core network 140 is used to support 5G communication operations with the satellite network and at a terrestrial 5G radio access network (RAN) 130. For instance, the 5G core network 140 may be located in a remote location, and use the satellite constellation 100 as the exclusive mechanism to reach wide area networks and the Internet. In other scenarios, the 5G core network 140 may use the satellite constellation 100 as a redundant link to access the wide area networks and the Internet; in still other scenarios, the 5G core network 140 may use the satellite constellation 100 as an alternate path to access the wide area networks and the Internet (e.g., to communicate with networks on other continents).

FIG. 1 additionally depicts the use of the terrestrial 5G RAN 130, to provide radio connectivity to a user equipment (UE) such as user device 120 or vehicle 125 on-ground via a massive MIMO antenna 150. It will be understood that a variety of 5G and other network communication components and units are not depicted in FIG. 1 for purposes of simplicity.

In some examples, each UE 120 or 125 also may have its own satellite connectivity hardware (e.g., receiver circuitry and antenna), to directly connect with the satellite constellation 100 via satellite link 180. This satellite link 180 may be used to provide a SCS connection via a 5G frequency band, as discussed in more detail below. Although aspects of 5G networking and SCS are discussed at length in the following sections, it will be apparent that variations of 3GPP, O-RAN, and other network specifications may also be applicable.

Other permutations (not shown) may involve a direct connection of the 5G RAN 130 to the satellite constellation 100 (e.g., with the 5G core network 140 accessible over a satellite link); coordination with other wired (e.g., fiber), laser or optical, and wireless links and backhaul; multi-access radios among the UE, the RAN, and other UEs; and other permutations of TN and NTN connectivity. Satellite network connections may be coordinated with 5G network equipment and user equipment based on satellite orbit coverage, available network services and equipment, cost and security, and geographic or geopolitical considerations, and the like. With these basic entities in mind, and with the changing compositions of mobile users and in-orbit satellites, the following techniques describe ways in which terrestrial and satellite networks can be coordinated to offer supplemental coverage from space via licensed or regulated communication bands.

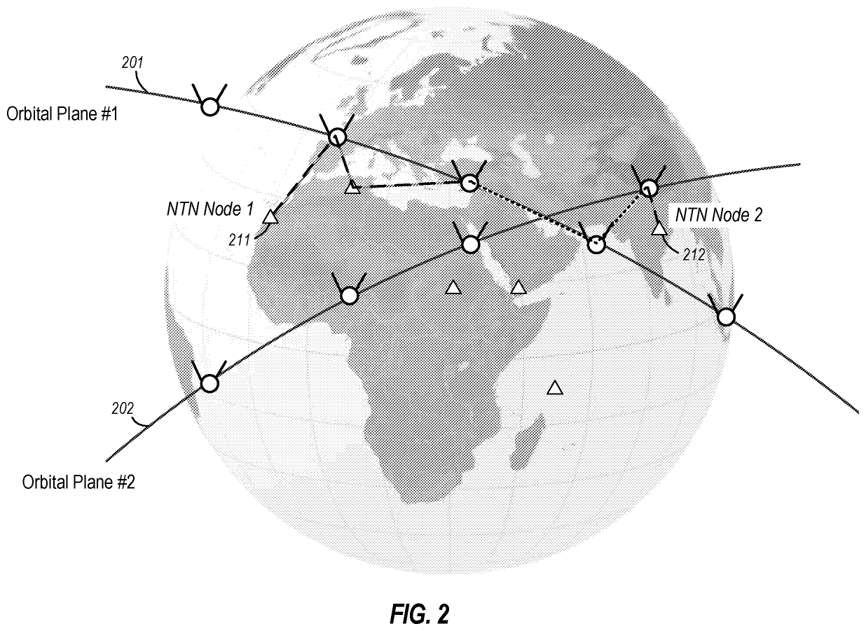

FIG. 2 depicts a geographical map showing how an NTN network or networks may include multiple constellations and orbital planes that provide service to multiple geographic areas. As shown, a first set of LEO satellites may operate in a first orbital plane 201, whereas a second set of LEO satellites may operate in a second orbital plane 202. The first and second set of LEO satellites may correspond to the same or different satellite service providers or networks. SCS may be offered to a particular user by one or more of these satellites to locations on earth when the user is out of a terrestrial coverage area (e.g., is out of range of a nearby terrestrial network tower, or in a remote geographic area not served by terrestrial network).

As a further complication to this scenario, NTN nodes located on earth may rely on connectivity from the NTN network to provide internet connectivity or network services to on-ground users. For example, consider a first NTN node 211 located in a first location and a second NTN node 212 located in second location in a different country, each of which hosts a local terrestrial 5G network for multiple connected users, with each country licensing or regulating different terrestrial 5G frequency bands and operational parameters. As a further complication, consider a setting where the NTN nodes 211, 212 coordinate with one another to host edge computing or networking services used by each network or the connected users.

As respective satellites traverse over different geographic areas, the satellites will encounter different regulations or conditions regarding the acceptable types of interferences. A variety of interference concerns may be raised from existing on-ground terrestrial network coverage (e.g., using the same or adjacent radio frequencies), or raised from the use of non-licensed or non-permitted frequencies among different countries. These interference concerns may multiply as space-originating transmissions are used for short periods of time from different constellations (and, potentially different service providers) from NTN networks for SCS and many other use cases.

SCS Interference Issues and Mitigations

Proposed United States FCC regulations explain that for SCS coverage, “Applicants for earth stations transmitting in frequency bands shared with equal rights between terrestrial and space services must provide a frequency coordination analysis . . . and must include any notification or demonstration required by any other relevant provision.” These regulations also explain that for new telecommunication applicants, “An earth station applicant shall also include in the application relevant technical details (both theoretical calculations and/or actual measurements) of any special techniques, such as the use of artificial site shielding, or operating procedures or restrictions at the proposed earth station which are to be employed to reduce the likelihood of interference, or of any particular characteristics of the earth station site which could have an effect on the calculation of the coordination distance.”

One such method of site shielding or restrictions can be accomplished through dynamic exclusion, inclusion, or coordination zones based on interference metrics, to establish a SCS Zone for a defined geographic area as discussed herein. SCS Zone definitions can be used to establish pre-determined interference limits and measurement placeholders at particular geographic areas, to apply when a LEO satellite transits over the defined geographic area. As set forth herein, an SCS Zone can be two-dimensional or three-dimensional, and can be attached and/or detached from the Earth.

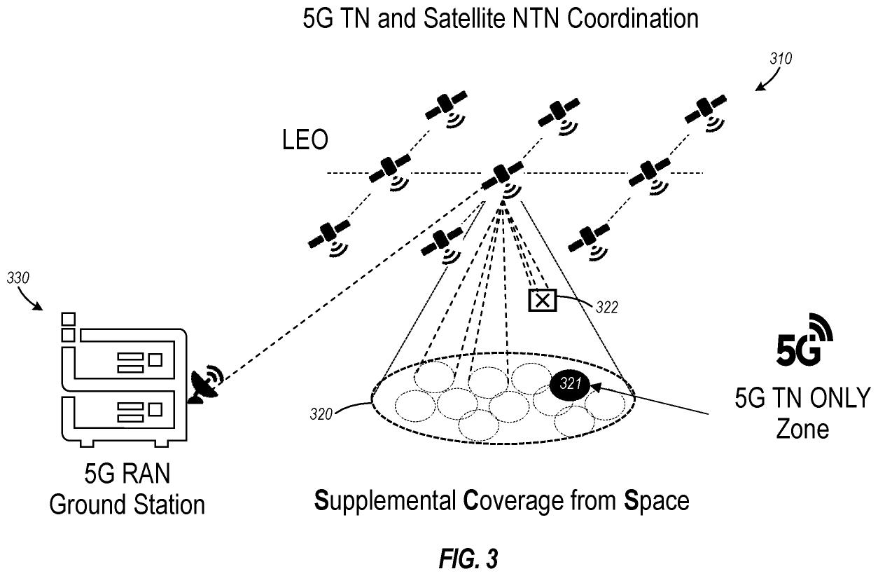

FIG. 3 illustrates a scenario of dynamic SCS interference mitigation. Here, an LEO satellite constellation 310 provides 5G SCS communications within a coverage area 320 on-earth, based on the use of one or multiple spot beams from each SV. The primary 5G coverage on earth is also provided on a smaller scale by various 5G TN base stations (not depicted). The LEO satellite constellation 310 and the 5G base stations are coordinated via a 5G RAN ground station 330 and other 5G network infrastructure.

In some settings, the 5G SCS communications and the 5G TN communications may co-exist. In other settings, dynamic measurements may be used to identify that the 5G SCS transmissions from space are interfering, have interfered, or are likely to interfere with a 5G TN location on-earth. In still other settings, regulations may require some separation between SCS and 5G TN communication frequencies, or outright prohibit the use of SCS communications in some areas or location. Based on the detection or prediction of this interference, regulation, or prohibition, a zone 321 is defined on Earth to prevent the use of 5G SCS transmissions in a particular area or location.

Specifically, a 5G TN only zone 321 may be defined to prohibit or regulate the use of some or all types of SCS communications in a specific area or location. As discussed herein, interference mitigation or prohibition in the 5G TN only zone 321 may be ensured based on an SCS Zone 322 that modifies the operation of SCS communications from the LEO constellation. As shown, this SCS Zone 322 excludes a particular LEO SV from providing broadcasts onto the zone 321, by turning off one of its spot beams.

In an example, SCS Zones to mitigate interference at specific geographic areas are pre-determined and defined based on orbital angular momentum (OAM) operation and maintenance telemetry. This telemetry is collected sent to ground stations for processing (e.g., at the 5G RAN ground station 330, or at satellite data processing locations). Based on such measurements, a SCS Zone definition can established and be adjusted according to set limits in the zone at a geographic area (e.g., to apply when the SV would be transiting over the geographic area), and then applied for use by the LEO constellation.

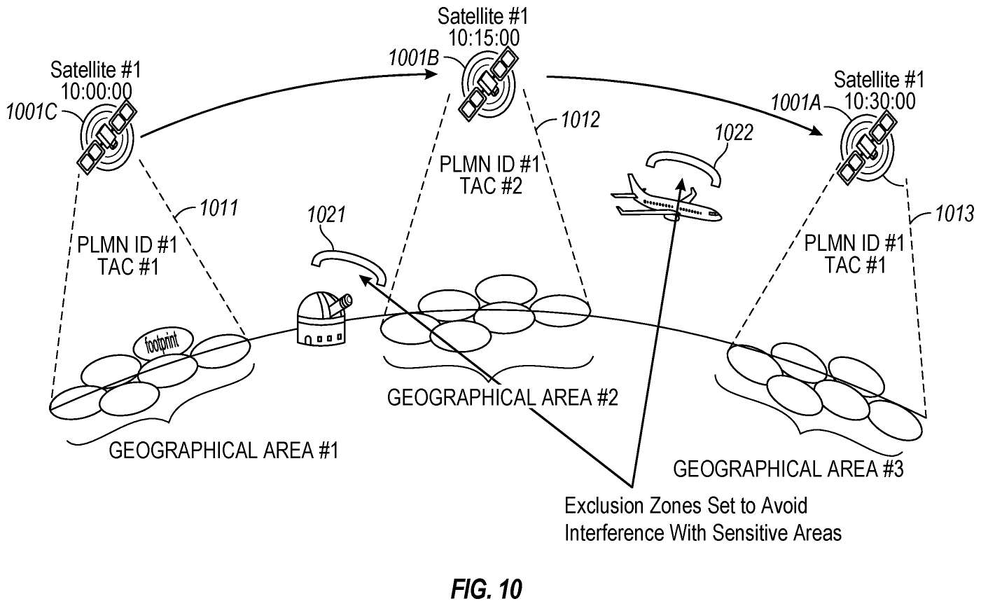

This SCS Zone definition may include characteristics to exclude operation via an exclusion condition (e.g., an “exclusion zone” or “EZ” to exclude use of some or all radio frequencies or frequency bands), to coordinate operations via a coordination condition (e.g., a “coordination zone” or “CZ” to reduce power or to change frequencies or frequency bands), or allow operation via an inclusion condition (e.g., an “inclusion zone” or “IZ” to always permit use of some frequencies or frequency bands, such as for emergency communications). More details for implementing aspects of an EZ, CZ, and IZ in an NTN are provided below, with reference to FIGS. 10 to 16D and the accompanying text. Additionally, although the SCS Zone 322 depicted in FIG. 3 and discussed above refers to the modification of SCS and NTN operations, it will be understood that TN and on-earth 5G operations may also be modified to detect and adapt to interference. Thus, any combination of TN and NTN zones may be defined and coordinated with the following SCS dynamic interference mitigation techniques.

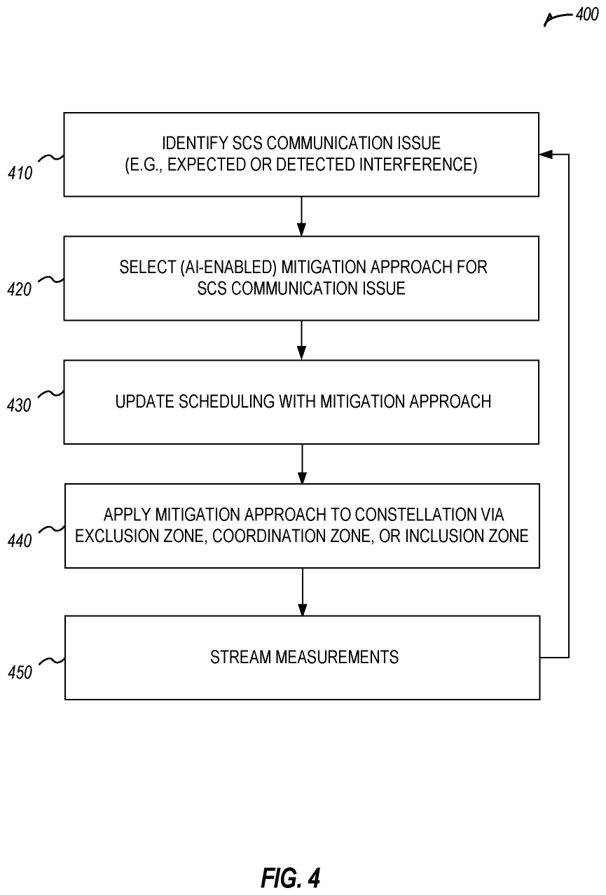

FIG. 4 depicts a flowchart 400 of a method for implementing dynamic SCS interference mitigation. The operations of this method may be performed by pre-processing network data at a ground station or at a connected computing location (e.g., cloud or edge computing location). However, some operations or other adaptations of this method may be performed by satellite hardware.

At 410, an expected, detected, and/or a mitigated SCS communication issue is identified, such as interference with communications from a 5G TN. This may include identifying an ongoing condition from an interference concern, predicting that interference is expected, or detecting another condition where a mitigation is beneficial or required.

A detected communication issue can be measured by a third-party that is separate from an NTN constellation provider, such as where an expected communication issue is predicted by a regulatory body or by an active artificial intelligence (AI) model operated by a third party service provider. In some examples, a mitigation for an SCS communication issue may need to be identified (and, the mitigation strategy identified and/or validated) in order to acquire licensing and or other operational approvals for operation of SCS services. A mitigated issue may be based on a placeholder for measurement data, especially when a licensed (e.g., regulated) spectrum (e.g., frequency bands) originally intended for a traditional communications services provider is used for SCS coverage.

At 420, an SCS communication issue mitigation approach is identified and selected, such as based on the use of AI-enabled models or data analysis. These models and data analysis may include approaches such as neural networks or machine learning models that detect and generate mitigation approaches, based on detected model inputs. A variety of machine learning or AI-enabled models can be generated, trained, executed, and/or originate at the ground station, space constellation, and/or a combination of these and other locations.

Avoidance or mitigation of the interference issue may include one or more of the following changes that can be implemented in an SCS Zone: transmit power reduction; selection of different frequencies; selection of different antennas; selection of different ground stations; or SV orbit maneuvers.

At 430, scheduling is conducted to implement mitigation with the SCS Zone, which creates or updates an exclusion, inclusion, and/or coordination zone based on the mitigation approach.

Further avoidance may be scheduled based on Real-Time Link Budget Analysis, including the use of an AI-enabled analysis as appropriate for high-fidelity satellite and ground station layout changes, downlink bandwidth monitoring, and actual link conditions. Other avoidance techniques may be scheduled or coordinated based on: RFI (radio frequency interference) as determined by CNR (carrier-to-noise ratio) and/or EPFD (Equivalent Power Flux Density) measurements or values; ground station coverage; and government (e.g., FCC) authorizations.

At 440, a mitigation approach is applied to a constellation (or, individual SVs of a constellation) via an exclusion zone, coordination zone, inclusion zone, or some combination defined with the SCS Zone.

The automatic use of active measurements can enable a self-correcting mechanism. At 450, measurements are streamed and further monitored. Additional operations may be repeated based on changed measurements and real-time conditions.

As non-limiting examples, sources of interference may include any of the following: RF interference (e.g., satellite-to-ground station or ground station-to-satellite; Carrier/Noise+Interference<Receiver Sensitivity; percentage or duration of EPFD time; EPFD up/down/inter-satellite limits). Causes of interference may include any of the following: incorrectly operating equipment; scheduling mistakes; orbit maneuvers; natural interference (solar, ionospheric); electromagnetic interference (e.g., terrestrial microwave or C-band interference at a ground station); equipment failure (e.g., at the satellite or ground station).

In some examples, detection of interference may be provided by analysis of data measurements provided from one or more of the following: Bit Error Rate; Carrier to Noise Ratio; Flux Density; Received Isotropic Power (RIP); Effective Isotropic Radiated Power (EIRP); Antenna Gain; or Proximity constraints (e.g., a fly-by exclusion zone).

In addition to the issues noted above, other measurements may relate to the detection of conditions based on: debris; downlink data bandwidth; RFI; ground station coverage; government (e.g., FCC) restrictions; natural (solar, ionospheric) interference; satellite position changes (e.g., attitude changes in LEO constellations) that impact antenna gain, RF received power, or EIRP; LEO constellation hardware/silicon specification deviations that affect the amount of power a satellite has in real-time to adjust antenna power, ground station low noise amplification, satellite altitude and line of sight to ground station, or dipole/phased array antenna gains; Bit Error Rate; Carrier to Noise Ratio; Flux Density; RIP or EIRP; Antenna Gain; or Proximity constraints (e.g., based on a fly-by exclusion zone).

As further examples, any combination of the following dynamic interference mitigation may be detected and responded to with a SCS Zone exclusion, coordination, or inclusion condition as follows:

TABLE 1

| | Measurement in | |
|---|---|---|
| Interference | SCS Zone | |
| Type | Definition | Action/Benefit |
| Terrestrial | Co-channel | Adjust EZ to accommodate pre- |
| Interference | interference | determined limits so that |
| | measurement | terrestrial and non-terrestrial |
| | | channel usage is |
| | | indistinguishable |
| Satellite | Satellite Antenna | Adjust EZ to comply with |
| Interference | Angle | normative guardrails such as ITU |
| | measurement | Recommendation S.1528 for |
| | (dBi) | far-out sidelobes (e.g., off-axis |
| | | angles over 60 degrees) to be 0 dB |
| Cross-Border | Power Flux | Adjust EZ to align with PFD |
| Interference | Density (PFD) | guardrails |
| Adjacent-band | Frequency | Adjust EZ for compliance with |
| Interference | Stability | frequency stability rules in Section |
| | | 24.235 and out-of-band limits in |
| | | Section 24.238 |
| Radio | Light allowance | Adjust EZ in accordance |
| Astronomy | in compliance with | with light tolerance |
| Interference | NRQZ (National | levels within NRQZs |
| | Radio Quiet | |
| | Zones) | |

Information elements may apply to identify the preceding types of measurements as follows:

TABLE 2

| Type | Information Elements |
|---|---|
| Terrestrial | Earth-Station bit or block error rate (BER/BLER) |
| Measurements | Earth-Station Signal-to-Noise Ratio (SNR) |
| | Earth-Station Channel State Information (CSI) |
| | Earth-Station Channel Impulse Response |
| | Earth-Station Reference Signal Fingerprint (e.g., |
| | varies by time) |
| | Earth-Station Reference Signal Received Power |
| | (RSRP) |
| | Earth-Station Reference Signal Received Quality |
| | (RSRQ) |
| | Earth-Station packets transmitted |
| | Earth-Station packets re-transmitted |
| | Earth-Station packets dropped |
| | Earth-Station number of handovers |
| | Earth-Station dropped calls or sessions |
| | Earth-Station local communication services |
| | provider allowed frequencies |
| | Earth-Station local emergency allowed frequencies |
| Satellite | Satellite-to-earth (line of sight (LOS) and non- |
| Measurements | line of sight (NLOS)) statistics or measurements |
| | based on: |
| | Satellite BLER/BER |
| | Satellite SNR |
| | Satellite CSI |
| | Satellite Channel Impulse Response |
| | Satellite Reference Signal Fingerprint (e.g., varies |
| | by time) |
| | Satellite RSRP |
| | Satellite RSRQ |
| | Satellite packets transmitted |
| | Satellite packets re-transmitted |
| | Satellite packets dropped |
| | Satellite number of handovers |
| | Satellite dropped calls or sessions |
| | Satellite communication services provider allowed |
| | frequencies |
| | Satellite local emergency allowed frequencies |
| | Satellite inter-satellite link (ISL) statistics or |
| | measurements (including any of the statistics for |
| | LOS or NLOS Satellite-to-Earth statistics as above) |

Any of the previous statistics or measurements may be evaluated (and used to identify or modify/adapt an SCS Zone) based on the use of counters, maximum or minimum values, value ranges, or other evaluative data. Additionally, it will be understood that the use of satellite-to-earth and ISL counters and measurements may be considered as part of optimizing constellation performance and operational conditions. ISL communications are particularly sensitive to orbital shifts that trigger the need for orbital adjustments and updated routing tables. An SCS Zone and AI-identified adjustments, as discussed herein, may be used to not only detect and respond to interference mitigation of earth-to-ground transmissions, but also to detect and respond to various interference scenarios within the constellation itself (or, between multiple constellations). Further, the characteristics of each EZ, IZ, or CZ in an SCS Zone can be AI generated using a combination of counters and measurements that feed into (optional) learning models on Earth or at in-orbit processing locations, depending on architectures.

The resulting interference mitigations provide particular benefits for the deployment of SCS connectivity. With the use of dynamic interference mitigations, connectivity from SCS can be treated as a form of a network “slice” that is dynamic and flexible, yet is fully manageable by service providers. Thus, even as service providers and telecommunication systems continue to expand connectivity, the network slice can be configured to maintain compatibility and reliability to respond to interference scenarios.

Network slices can be defined and configured to support different SCS interference/expected-interference/mitigated-interference requirements. As such it is possible that each slice has unique or shared SCS_ZONES, implementing some form of an EZ, CZ, or IZ. The use of a network slice may also enable operation of a “probation”, “test”, or “trial” slice which serves as a precautionary way to determine whether unexpected interference is or is not occurring based on variable factors. For example, an initial “testing” slice can be defined as a first zone (SCS_ZONE_P1) to log and monitor the prospective use of a terrestrial licensed frequency for SCS, whereas other zones are used to mitigate known types of interference. Thus, SCS_ZONE_P1 in the chart below is defined to identify adjacent-interference during a testing or investigatory period.

An example layout of network slices and SCS Zone adaptations may be established as follows:

TABLE 3

| Slice | Intent | SCS_ZONE(s) |
|---|---|---|
| P1 | Testing | Adjacent-interference + |
| | | Terrestrial Interference |
| P2 | Experimental | Radio Astronomy Interference |
| P3 | Operation | Terrestrial Interference |
| | | Satellite Interference |
| | | Cross-Border Interference |
| | | Adjacent-band Interference |
| | | Radio Astronomy Interference |

In this example, there are different network slices which are subject to different outcomes. Here, the first slice SCS_ZONE_P1 is established in a probationary mode to measure what types of interference is adjacent and which is occurring; a second slice SCS_ZONE_P2 is established in an experimental mode to determine what type of radio astronomy interference does or does not occur; and a third slice SCS_ZONE_P3 is established in an operational mode to actively mitigate interference from terrestrial, satellite, cross-border, adjacent-band, and radio-astronomy sources.

Different slices may be defined based on the particular provider or source, and different requirements for how information is shared. There may be different types of public and private personas for different slices and zones, and not all information may be shared with other parties or made public, for example. The actual implementation of the generation of the measurements might be proprietary to a particular satellite constellation operator, in some examples. In other examples, the reporting of the measurements within the SCS Zone (related to the use of the EZ/CZ/IZ) is provided as public records to provide regulatory agencies (in one or multiple countries) with on-going telemetry necessary to cross-check compliance.

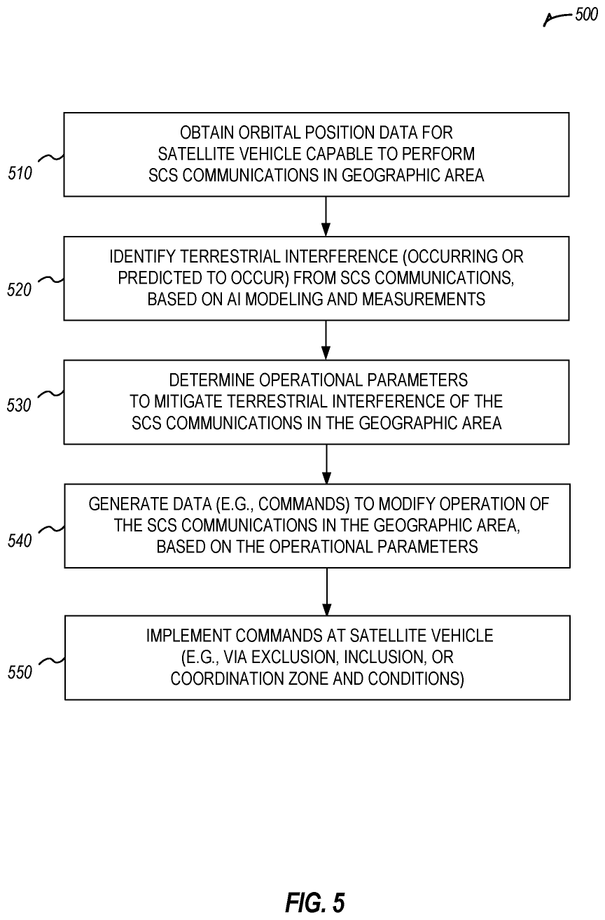

FIG. 5 illustrates a flowchart 500 of an example method of implementing dynamic SCS interference mitigation. This method may be modified based on the examples discussed throughout this document relating to interference and conditions for exclusion, inclusion, or coordination of particular terrestrial-SCS communications.

Operation 510 includes obtaining (e.g., retrieving, identifying, etc.) orbital position data for at least one low-earth orbit (LEO) satellite vehicle (SV), that is capable to perform supplemental coverage from space (SCS) network communications. As discussed herein, the use of a SCS Zone to modify the use of the SCS network communications may span and impact individual or multiple LEO SVs that sustain a short or long communication contact to an affected area or TN. For example, multiple LEO SVs may be used to support different SCS contact types within a SCS Zone, as short as a short message burst, or as long as hours or days (using multiple intercepting SVs configured to handover SCS communications without dropping the communication contact). These SCS network communications may be configured to operate in at least one regulated frequency band, consistent with FCC regulations or with other regulations or standards. The interference discussed in these operations may relate to a terrestrial network configured to operate in a 4G Long Term Evolution (LTE) or 5G Fifth Generation network, operating in the same or nearby at least one regulated frequency band according to a 3GPP standard.

Operation 520 includes identifying terrestrial interference of the SCS network communications (predicted to occur, or occurring) with a terrestrial network located in a two-dimensional or three-dimensional space corresponding to a geographic area. The geographic area may be identified or analyzed based on based on the orbital position data obtained in operation 510. The two-dimensional or three-dimensional space may be transposed based on the characteristics of the geographic area, or the particular type of interference to be mitigated with an SCS zone. For example, a transposed SCS zone may apply to an aircraft or balloon whose footprint is transposed onto a geographic area on earth, and then translated to coordinates that are applied into scheduling decisions as follows.

The operation 520 to identify the terrestrial interference may be performed with use of an artificial intelligence (AI) model. The AI model may evaluate or process multiple measurements corresponding to the at least one LEO SV or the terrestrial network. For instance, the terrestrial interference may be identified by the AI model based on at least one measurement of radio interference observed (ongoing or previously measured) or predicted between the SCS network communications and the terrestrial network. In one example, the AI model comprises an earth-centric learning model that is generated for Earth-based measurement evaluation consistent with an SCS Zone. In another example, the AI model comprises a space-centric learning model that is generated for Space-based measurement evaluation consistent with an SCS Zone. In yet another example, the AI model comprises a hybrid learning model that is generated based on both earth-centric and space-centric measurement evaluation consistent with an SCS Zone. In these scenarios, the SCS zone may be defined and evaluated, based on predicted or evaluated interference that corresponds to the geographic area or a transposed two-dimensional or three-dimensional space.

Operation 530 includes determining operational parameters to mitigate the predicted or ongoing terrestrial interference of the SCS network communications with the terrestrial network. In an example, the terrestrial interference is determined based on at least one prediction of co-channel interference to occur between the LEO SV and the terrestrial network with the SCS network communications.

Operation 540 includes to generate data (e.g., commands) that modify the operation of the SCS communications in the geographic area, based on the determined operational parameters. In an example, to modify the operation of the SCS network communications includes to define at least one zone that controls use of the SCS network communications onto the geographic area. In another example, to modify operation of the SCS network communications at a respective LEO SV includes to: change transmit power; change reception power; change use to at least one different frequency; change use to at least one different antenna; change use to at least one different ground station; or perform at least one additional orbit maneuver of the respective LEO SV. Also in further examples, data to modify operation of the SCS network communications in the geographic area, includes to schedule mitigation of the SCS network communications at the respective LEO SV before reaching an orbital position associated with coverage of the geographic area.

Operation 550 includes to implement commands at the SV via exclusion, inclusion, or coordination zone parameters and conditions (or, some combination of exclusion, inclusion, or coordination). For example, an exclusion zone may be defined to prohibit operation of a spot beam by a respective LEO SV, or to prohibit at least one frequency, frequency band, or characteristic of the SCS network communications in the geographic area. An inclusion zone may be defined to permit operation of at least one frequency, frequency band, or characteristic of the SCS network communications in the geographic area. A coordination zone may be defined to allow operation of at least one frequency, frequency band, or characteristic of the SCS network communications in the geographic area, based on changes to the SCS network communications to co-exist with communications of at least one other network.

In further examples, at least one measurement of radio interference (e.g., used to identify a possible, predicted, or ongoing interference) is based on communications with an earth station of the terrestrial network, with the at least one measurement based on at least one of: bit or block error rate; Signal-to-Noise Ratio (SNR); channel state information; channel impulse response; reference signal fingerprint; Reference Signal Received Power (RSRP); Reference Signal Received Quality (RSRQ); a number of packets transmitted; a number of packets re-transmitted; a number of packets dropped; a number of handovers; or a number of dropped calls or sessions. These measurements (e.g., RSRP, RSRQ, SNR) may be captured and calculated per-antenna. In other examples, the operations to identify the terrestrial interference are based on a detected or predicted condition identified by the AI model, relating to causes such as at least one of: debris; downlink data bandwidth; ground station coverage; government restrictions; solar or ionospheric interference; electromagnetic interference; satellite position changes; bit error rate; carrier to noise ratio; flux density; received isotropic power (RIP); effective isotropic radiated power (EIRP); antenna gain; or proximity constraints.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a computing system, comprising: processing circuitry; and a memory device including instructions embodied thereon, wherein the instructions, which when executed by the processing circuitry, configure the processing circuitry to perform operations that: obtain orbital position data for at least one satellite vehicle (SV) (e.g., low-earth orbit (LEO) SV), the at least one SV capable to perform supplemental coverage from space (SCS) network communications; determine operational parameters to mitigate terrestrial interference of the SCS network communications on a terrestrial network located in a two-dimensional or three-dimensional space corresponding to a geographic area, the space identified based on the orbital position data; and generate data to modify operation of the SCS network communications from the at least one SV to the geographic area, based on the determined operational parameters.

In Example 2, the subject matter of Example 1 optionally includes subject matter where the data to modify operation of the SCS network communications to the geographic area, includes to schedule mitigation of the SCS network communications in the at least one SV before reaching an orbital position associated with coverage of the geographic area.

In Example 3, the subject matter of any one or more of Examples 1-2 optionally include subject matter where the instructions further configure the processing circuitry to perform operations that: identify the terrestrial interference of the SCS network communications with a model (e.g., an artificial intelligence (AI) model), based on multiple measurements corresponding to the at least one SV or the terrestrial network.

In Example 4, the subject matter of Example 3 optionally includes subject matter where the model comprises an earth-centric learning model that is generated for Earth-based measurement evaluation consistent with an SCS Zone, the SCS zone corresponding to the geographic area or a transposed two-dimensional or three-dimensional space.

In Example 5, the subject matter of any one or more of Examples 3-4 optionally include subject matter where the model comprises a space-centric learning model that is generated for Space-based measurement evaluation consistent with an SCS Zone, the SCS zone corresponding to the geographic area or a transposed two-dimensional or three-dimensional space.

In Example 6, the subject matter of any one or more of Examples 3-5 optionally include subject matter where the model comprises a hybrid learning model that is generated based on both earth-centric and space-centric measurement evaluation consistent with an SCS Zone, the SCS zone corresponding to the geographic area or a transposed two-dimensional or three-dimensional space.

In Example 7, the subject matter of any one or more of Examples 3-6 optionally include subject matter where the terrestrial interference is identified by the model based on at least one measurement of radio interference observed between the SCS network communications and the terrestrial network.

In Example 8, the subject matter of Example 7 optionally includes subject matter where the at least one measurement of the radio interference is based on communications with an earth station of the terrestrial network.

In Example 9, the subject matter of Example 8 optionally includes subject matter where the at least one measurement is based on at least one of: bit or block error rate; Signal-to-Noise Ratio (SNR); channel state information; channel impulse response; reference signal fingerprint; Reference Signal Received Power (RSRP); Reference Signal Received Quality (RSRQ); a number of packets transmitted; a number of packets re-transmitted; a number of packets dropped; a number of handovers; or a number of dropped calls or sessions.

In Example 10, the subject matter of any one or more of Examples 8-9 optionally include subject matter where the at least one measurement is based on at least one of: Signal-to-Noise Ratio (SNR); Reference Signal Received Power (RSRP); or Reference Signal Received Quality (RSRQ), and wherein SNR, RSRQ, RSRP values are calculated per antenna.

In Example 11, the subject matter of any one or more of Examples 3-optionally include subject matter where to identify the terrestrial interference is based on a detected or predicted condition identified by the model.

In Example 12, the subject matter of Example 11 optionally includes subject matter where the detected or predicted condition relates to at least one of: debris; downlink data bandwidth; ground station coverage; government restrictions; solar or ionospheric interference; electromagnetic interference; satellite position changes; bit error rate; carrier to noise ratio; flux density; received isotropic power (RIP); effective isotropic radiated power (EIRP); antenna gain; or proximity constraints.

In Example 13, the subject matter of any one or more of Examples 1-12 optionally include subject matter where the terrestrial interference is determined based on at least one prediction of co-channel interference to occur between the at least one SV and the terrestrial network with the SCS network communications.

In Example 14, the subject matter of Example 13 optionally includes subject matter where to modify operation of the SCS network communications at a respective SV includes to: change transmit power; change reception power; change use to at least one different frequency; change use to at least one different antenna; change use to at least one different ground station; or perform at least one additional orbit maneuver of the respective SV.

In Example 15, the subject matter of any one or more of Examples 1-14 optionally include subject matter where to modify operation of the SCS network communications includes to define at least one zone that controls use of the SCS network communications onto the geographic area.

In Example 16, the subject matter of Example 15 optionally includes subject matter where the at least one zone includes at least one of: an exclusion zone defined to prohibit operation of a spot beam by a respective SV, or to prohibit at least one frequency, frequency band, or characteristic of the SCS network communications in the geographic area; an inclusion zone defined to permit operation of at least one frequency, frequency band, or characteristic of the SCS network communications in the geographic area; or a coordination zone to allow operation of at least one frequency, frequency band, or characteristic of the SCS network communications in the geographic area, based on changes to the SCS network communications to co-exist with communications of at least one other network.

In Example 17, the subject matter of any one or more of Examples 1-16 optionally include subject matter where the terrestrial network is a 4G Long Term Evolution (LTE) or 5G Fifth Generation network operating in at least one regulated frequency band according to a 3GPP standard.

In Example 18, the subject matter of Example 17 optionally includes subject matter where the SCS network communications are to operate in the at least one regulated frequency band.

In Example 19, the subject matter of any one or more of Examples 1-18 optionally include subject matter where the instructions further configure the processing circuitry to perform operations that: transmit data to the SCS network or an operator of the SCS network, to cause the modified operation of the SCS network communications in the geographic area.

In Example 20, the subject matter of any one or more of Examples 1-19 optionally include subject matter where the orbital position data is based on planned trajectory data of the at least one SV, and wherein to modify operation of the SCS network communications to the geographic area is based on implementing an SCS Zone before a respective SV of the at least one SV communicates to the geographic area or the two-dimensional or three-dimensional space corresponding to the geographic area.

Example 21 is a method, comprising a plurality of operations executed with a processor and memory of a device, to dynamically mitigate interference in a supplemental coverage from space (SCS) network arrangement, comprising: obtaining orbital position data for at least one satellite vehicle (SV) (e.g., low-earth orbit (LEO) SV), the at least one SV capable to perform supplemental coverage from space (SCS) network communications; determining operational parameters to mitigate terrestrial interference of the SCS network communications on a terrestrial network located in a two-dimensional or three-dimensional space corresponding to a geographic area, the geographic area identified based on the orbital position data; and modifying operation of the SCS network communications from the at least one SV to the geographic area, based on the determined operational parameters.

In Example 22, the subject matter of Example 21 optionally includes subject matter where modifying operation of the SCS network communications to the geographic area, includes to schedule mitigation of the SCS network communications in the at least one SV before reaching an orbital position associated with coverage of the geographic area.

In Example 23, the subject matter of any one or more of Examples 21-22 optionally include identifying the terrestrial interference of the SCS network communications using a model (e.g., an artificial intelligence (AI) model), the identifying to be performed based on multiple measurements corresponding to the at least one SV or the terrestrial network.

In Example 24, the subject matter of Example 23 optionally includes subject matter where the model comprises an earth-centric learning model that is generated for Earth-based measurement evaluation consistent with an SCS Zone, the SCS zone corresponding to the geographic area or a transposed two-dimensional or three-dimensional space.

In Example 25, the subject matter of any one or more of Examples 23-24 optionally include subject matter where the model comprises a space-centric learning model that is generated for Space-based measurement evaluation consistent with an SCS Zone, the SCS zone corresponding to the geographic area or a transposed two-dimensional or three-dimensional space.

In Example 26, the subject matter of any one or more of Examples 23-optionally include subject matter where the model comprises a hybrid learning model that is generated based on both earth-centric and space-centric measurement evaluation consistent with an SCS Zone, the SCS zone corresponding to the geographic area or a transposed two-dimensional or three-dimensional space.

In Example 27, the subject matter of any one or more of Examples 23-26 optionally include subject matter where the terrestrial interference is identified by the model based on at least one measurement of radio interference observed between the SCS network communications and the terrestrial network.

In Example 28, the subject matter of Example 27 optionally includes subject matter where the at least one measurement of the radio interference is based on communications with an earth station of the terrestrial network.

In Example 29, the subject matter of Example 28 optionally includes subject matter where the at least one measurement is based on at least one of: bit or block error rate; Signal-to-Noise Ratio (SNR); channel state information; channel impulse response; reference signal fingerprint; Reference Signal Received Power (RSRP); Reference Signal Received Quality (RSRQ); a number of packets transmitted; a number of packets re-transmitted; a number of packets dropped; a number of handovers; or a number of dropped calls or sessions.

In Example 30, the subject matter of any one or more of Examples 28-29 optionally include subject matter where the at least one measurement is based on at least one of: Signal-to-Noise Ratio (SNR); Reference Signal Received Power (RSRP); or Reference Signal Received Quality (RSRQ), and wherein SNR, RSRQ, RSRP values are calculated per antenna.

In Example 31, the subject matter of any one or more of Examples 23-optionally include subject matter where to identify the terrestrial interference is based on a detected or predicted condition identified by the model.

In Example 32, the subject matter of Example 31 optionally includes the detected or predicted condition relating to at least one of: debris; downlink data bandwidth; ground station coverage; government restrictions; solar or ionospheric interference; electromagnetic interference; satellite position changes; bit error rate; carrier to noise ratio; flux density; received isotropic power (RIP); effective isotropic radiated power (EIRP); antenna gain; or proximity constraints.

In Example 33, the subject matter of any one or more of Examples 31-32 optionally include subject matter where the terrestrial interference is determined based on at least one prediction of co-channel interference to occur between the at least one SV and the terrestrial network with the SCS network communications.

In Example 34, the subject matter of any one or more of Examples 21-33 optionally includes subject matter where to modify operation of the SCS network communications at a respective SV includes to: change transmit power; change reception power; change use to at least one different frequency; change use to at least one different antenna; change use to at least one different ground station; or perform at least one additional orbit maneuver of the respective SV.

In Example 35, the subject matter of any one or more of Examples 21-34 optionally include subject matter where modifying operation of the SCS network communications includes defining at least one zone that controls use of the SCS network communications onto the geographic area.

In Example 36, the subject matter of Example 35 optionally includes subject matter where the at least one zone includes at least one of: an exclusion zone defined to prohibit operation of a spot beam by the SV, or to prohibit at least one frequency, frequency band, or characteristic of the SCS network communications in the geographic area; an inclusion zone defined to permit operation of at least one frequency, frequency band, or characteristic of the SCS network communications in the geographic area; or a coordination zone to allow operation of at least one frequency, frequency band, or characteristic of the SCS network communications in the geographic area, based on changes to the SCS network communications to co-exist with communications of at least one other network.

In Example 37, the subject matter of any one or more of Examples 21-36 optionally include subject matter where the terrestrial network is a 4G Long Term Evolution (LTE) or 5G Fifth Generation network operating in at least one regulated frequency band according to a 3GPP standard.

In Example 38, the subject matter of Example 37 optionally includes subject matter where the SCS network communications are to operate in the at least one regulated frequency band.

In Example 39, the subject matter of any one or more of Examples 21-38 optionally include transmitting data to the SCS network or an operator of the SCS network, to cause the modified operation of the SCS network communications in the geographic area.

In Example 40, the subject matter of any one or more of Examples 21-39 optionally include subject matter where the orbital position data is based on planned trajectory data of the at least one SV, and wherein to modify operation of the SCS network communications to the geographic area is based on implementing an SCS Zone before a respective SV of the at least one SV communicates to the geographic area or the two-dimensional or three-dimensional space corresponding to the geographic area.

Example 41 is a non-transitory computer-readable storage medium capable of storing instructions that, when executed, cause at least one processor of a computing system (or, other another hardware device) to perform the operations of any of the methods of Examples 21 to 40.

Edge Computing and Data Processing Via Satellite-Enabled Networks

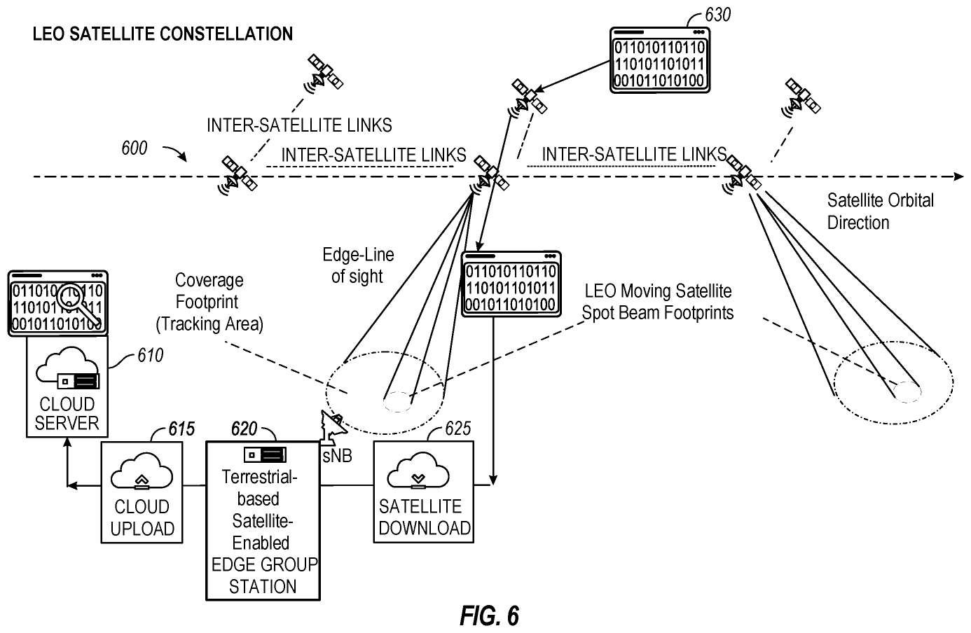

FIG. 6 illustrates an overview of terrestrial-based, satellite-enabled edge compute processing. As shown, a terrestrial-based, satellite enabled edge ground station (satellite nodeB, sNB) 620 obtains coverage from a satellite constellation 600, and downloads a data set 630. The constellation 600 may coordinate operations to handoff the download using inter-satellite links (such as in a scenario where the data set 630 is streamed, or cannot be fully downloaded before the satellite footprint moves).

The satellite download 625 is provided to the sNB 620 for processing, such as with a cloud upload 615 to a server 610 (e.g., a CDN located at or near the sNB 620). Accordingly, once downloaded to the sNB 620 (and uploaded to the server 610), the user devices located within the terrestrial coverage area (e.g., 5G coverage area) of the sNB 620 now may access the data from the server 610.

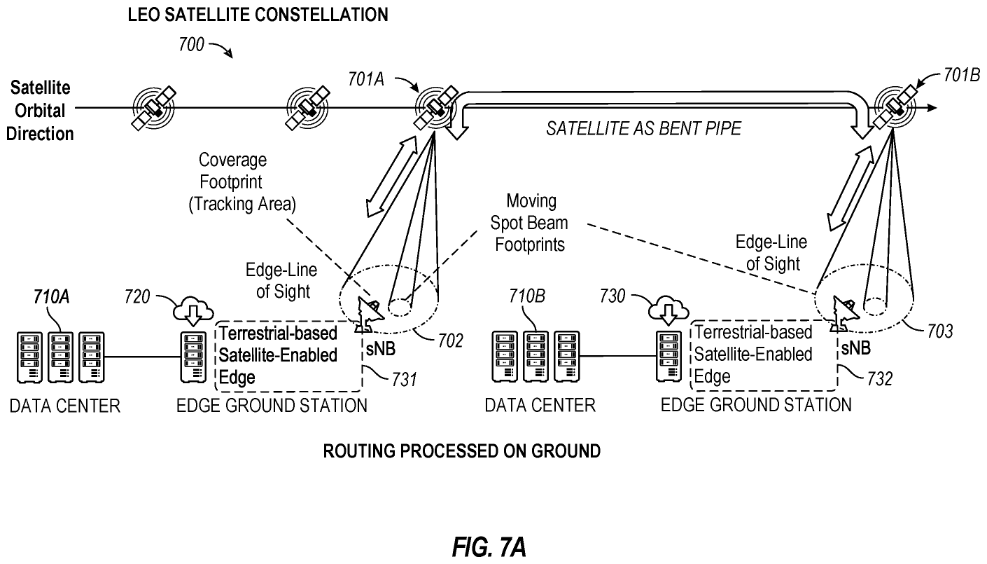

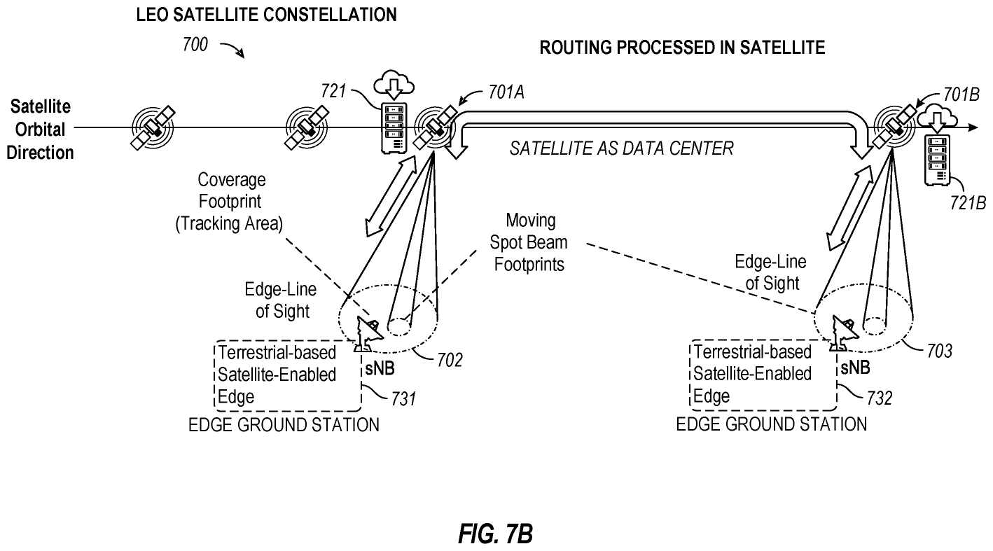

FIG. 7A illustrates a terrestrial-based, satellite-enabled edge processing arrangement, where routing is performed “on-ground” and the satellite network is used as a “bent pipe” between edge processing locations. Here, the term “bent pipe” refers to the use of a satellite or satellite constellation as a connection relay, to simply communicate data from one terrestrial location to another terrestrial location. As shown in this figure, a satellite 700 in a constellation has an orbital path, moving from position 701A to 701B, providing separate coverage areas 702 and 703 for connectivity at respective times.

Here, when a satellite-enabled edge computing node 731 (sNB) is in the coverage area 702, it obtains connectivity via the satellite 700 (at position 701A), to communicate with a wider area network. Additionally, this edge computing node 731 (sNB) may be located at an edge ground station 720 which is also in further communication with a data center 710A, for performing computing operations at a terrestrial location.

Likewise, when a satellite-enabled edge computing node 732 (sNB) is in the coverage area 703, it obtains connectivity via the satellite 700 (at position 701B), to communicate with a wider area network. Again, computing operations (e.g., services, applications, etc.) are processed at a terrestrial location such as edge ground station 730 and data center 710B.

FIG. 7B illustrates another terrestrial-based, satellite-enabled edge processing arrangement. Similar to the arrangement depicted in FIG. 7A, this shows the satellite 700 in a constellation along an orbital path, moving from position 701A to 701B, providing separate coverage areas 702 and 703 at respective times. However, in this example, the satellite 700 is used as a data center, to perform edge computing operations (e.g., serve data, compute data, relay data, etc.).

Specifically, at the satellite vehicle 700, edge computing hardware 721 is located to process computing or data requests received from the ground station computing nodes 731, 732 (sNBs) in the coverage areas 702, 703. This may have the benefit of removing the communication latency involved with another location at the wide area network. However, due to processing and storage constraints, the amount of computation power may be limited at the satellite 700 and thus some requests or operations may be moved to the ground station computing nodes 731, 732.

As will be understood, edge computing and edge network connectivity may include various aspects of RAN and software defined networking processing. Specifically, in many of these scenarios, wireless termination may be moved between ground and satellite, depending on available processing resources. Further, in these scenarios, URLLC (ultra-reliable low latency connections) processing may be enabled, based on the configuration of inter-satellite communication links.

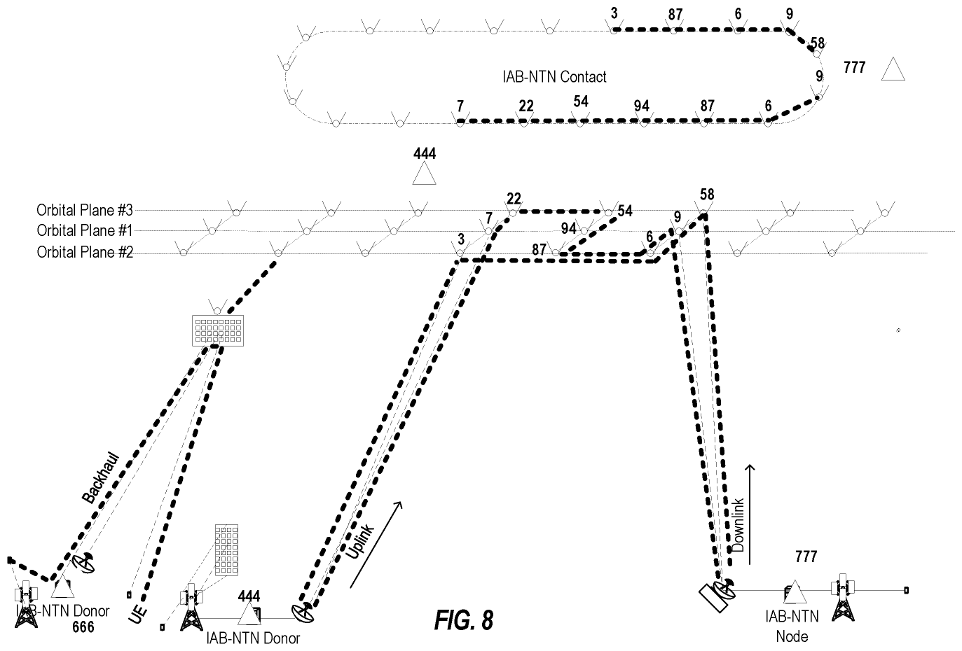

FIG. 8 provides a further illustration of how an NTN can enable uplink and downlink in an IAB setting, involving an IAB-NTN Donor (labeled as 444) and an IAB-NTN Node (labeled as 777). This example shows how a IAB Donor contact initiating at GS444 with line of sight to SV3 using GS777 resources then back to GS444 using optical ISLs while some SVs are still in LOS. However, in some scenarios, it may be faster to use SV down to terrestrial GS/relays than back up. In other words, a ground relay path may be faster than optical ISL SVs.

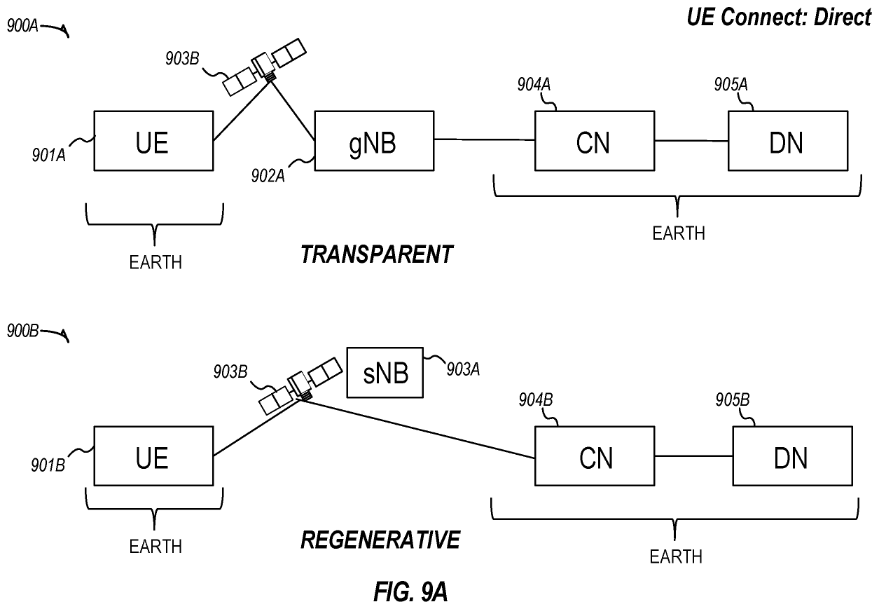

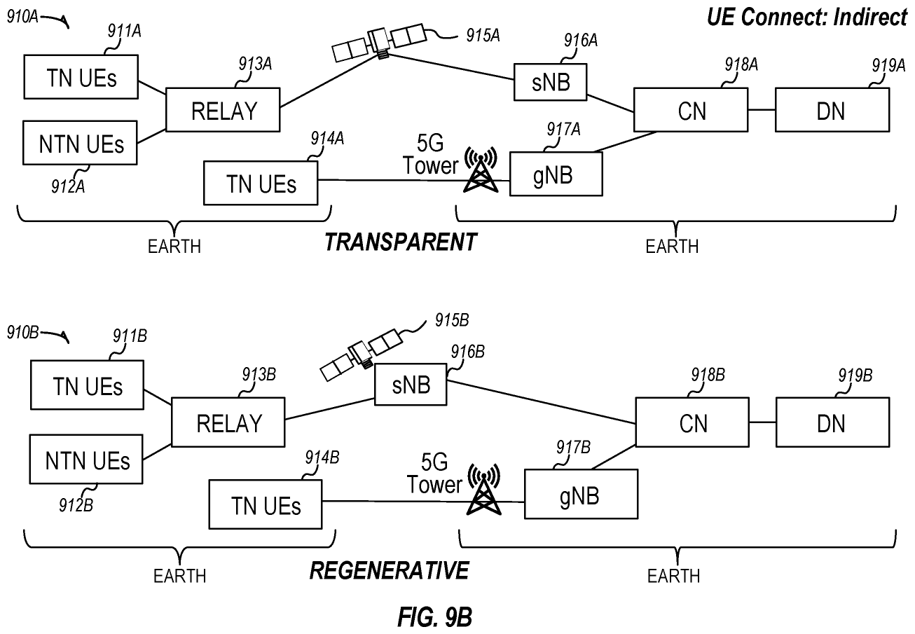

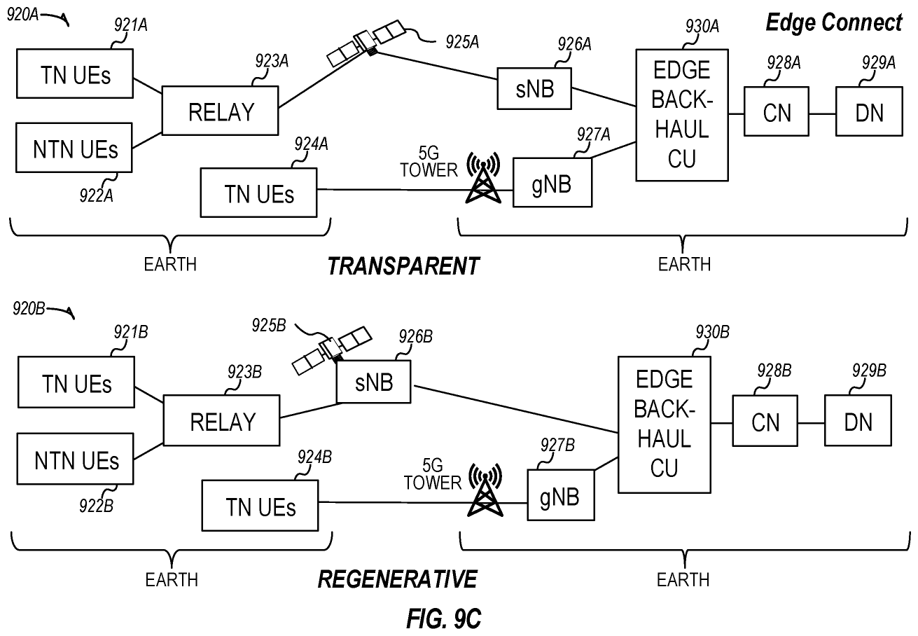

FIG. 9A, FIG. 9B, and FIG. 9C illustrate respective configurations of non-terrestrial and 5G network architectures, which may be used with the configurations and mitigation techniques discussed herein. These include:

Direct Connection (with a Transparent or “Bent Pipe” Satellite Arrangement):

Scenario 900A in FIG. 9A, e.g., Direct connect: UE 901A⇔[SATELLITE] 903B⇔gNB 902A⇔CN 904A⇔DN 905A;

Scenario 910A in FIG. 9B, e.g., Multi-RAT, Multi Connectivity provided by transparent NTN-based NG-RAN and Cellular NG-RAN: UEs 911A or 912A⇔Relay 913A⇔[SATELLITE] 915A⇔gNB 916A⇔CN 918A⇔DN 919A (in this scenario 910A, TN UEs 914A can directly connect to a gNB 917A and the CN 918A, DN 919A).

Scenario 920A in FIG. 9C, e.g., Multi-RAT, Multi Connectivity provided by transparent NTN-based NG-RAN and Cellular NG-RAN: UEs 921A or 922A⇔Relay 923A⇔[SATELLITE] 925A⇔sNB 926A⇔Edge back-haul centralized unit (CU) 930A⇔CN 928A⇔DN 929A (in this scenario 910A, TN UEs 924A can directly connect to a gNB 927A and the CN 928A, DN 929A via the Edge back-haul CU 930A).

Direct Connection (with a Regenerative Satellite with gNB Arrangement):

Scenario 900B in FIG. 9A: UE 901B⇔sNB 903A [at SATELLITE 903B]⇔CN 904B⇔DN 905B;

Scenario 910B in FIG. 9B, e.g., Multi-RAT, Multi Connectivity provided by transparent NTN-based NG-RAN and Cellular NG-RAN: UEs 911B or 912B⇔Relay 913B⇔sNB 916B [at SATELLITE 915B]⇔CN 918B⇔DN 919B (in this scenario 910B, TN UEs 914B can directly connect to a gNB 917B and the CN 918B, DN 919B).

Scenario 920B in FIG. 9C, e.g., Multi-RAT, Multi Connectivity provided by transparent NTN-based NG-RAN and Cellular NG-RAN: UEs 921B or 922B⇔Relay 923B⇔sNB 926B [at SATELLITE 925B]⇔Edge back-haul CU 930B⇔CN 928B⇔DN 929B (in this scenario 920B, TN UEs 924B can directly connect to a gNB 927B and the CN 928B, DN 929B via the Edge back-haul CU 930B).

### Further Examples of Exclusion Zones and Exclusion Zone Implementations

FIG. 10 illustrates an implementation of SV-based exclusion zones for a non-terrestrial communication network, according to an example. This drawing provides additional detail on an example deployment of exclusion zones, over time, relative to a satellite at orbit positions 1001A, 1001B, 1001C. At position 1001A, the satellite provides coverage of its spot beam(s) in a first geographic area 1011; at position 1001B, the satellite provides coverage of its spot beam(s) in a second geographic area 1012; at position 1001C, the satellite provides coverage of its spot beam(s) in a third geographic area 1013.

FIG. 10 shows the implementation of a first exclusion zone 1021, which is a fixed geographic exclusion area. A fixed geographic exclusion area may be appropriate for preventing overlap with terrestrial networks which would conflict (e.g., cells established from a 4G/5G mobile network), or a fixed areas which is designated to instructed to be avoided (e.g., other countries, radio silence areas, sensitive monitoring equipment such as radio telescopes). FIG. 10 further shows the implementation of a second exclusion zone 1022, which is a mobile geographic exclusion area. A mobile geographic area may be appropriate for objects or areas which are in motion, moveable, or whose position is not necessarily fixed in a specific geographic area (e.g., airplanes, drones, other satellites), or for an area that has an irregular or changing shape. The implementation of either type of exclusion zone prevents the satellite from beaming on the area of conflict or restriction.

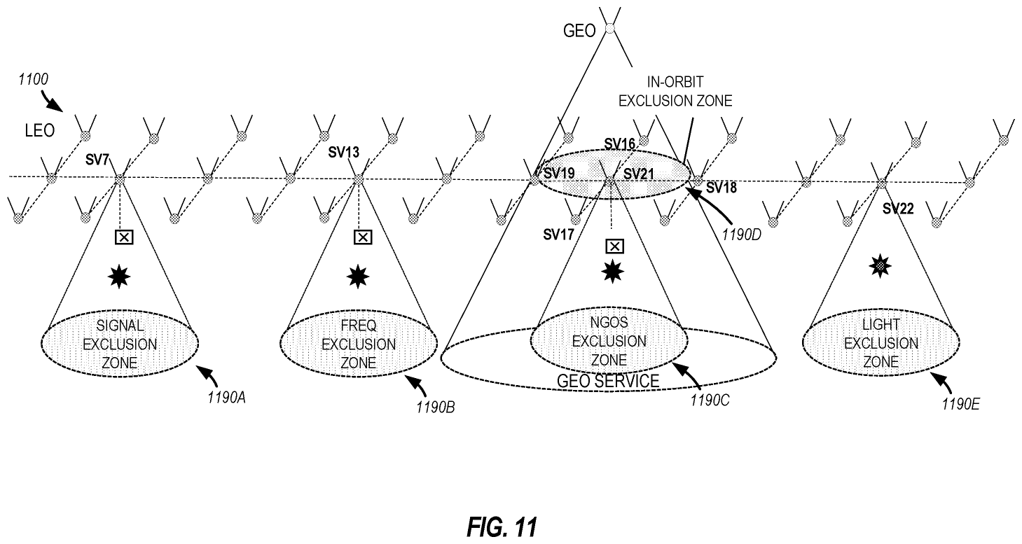

FIG. 11 illustrates further scenarios of network connectivity from an expanded view of a satellite constellation 1100, with the constellation comprising dozens of LEO satellites that provide connectivity to ground UEs (not shown). Within this scenario, a number of different exclusion zones are shown for deployment: a signal exclusion zone 1190A which blocks all signals from reaching a geographic area; a frequency exclusion zone 1190B which blocks certain frequency signals or frequency bands from reaching a geographic area; an non-geostationary orbit satellite (NGOS) exclusion zone 1190C which restricts signals from reaching a certain area which overlaps geostationary satellite service; an in-orbit exclusion zone 1190D which restricts inter-satellite communications which occur in an overlap of geostationary satellite service; and a light pollution exclusion zone 1190E which restricts reflection or causes some light reflection mitigation effect relative to an geographic area. Such exclusion zones 1190A-E may be separately or concurrently deployed with one another.

In the context of FIGS. 10 and 11, exclusion zones and inter-satellite links can apply to multiple constellations serviced by separate providers. For instance, different constellations may have separate GMSS identifiers (e.g., satellite equivalent of PLMN). Exclusion zones may intercept all applicable constellations, since EZs are typically “fixed” and are independent of the constellation ownership and/or providers.

Pre-determined LEO routing is used to maintain orbit and ISL connectivity alignment, and may be required to be communicated to the LEO vehicles on a frequent basis, such as each day. Exclusion zones among ISLs may be implemented to be coordinated with planned network routing calculations and communications that already occur among ground and space nodes of the LEO network. For instance, the regular communication of routing information that is provided to LEO vehicles may also be used to provide a specification of multiple EZs at the same time (including, exclusion zones defined between SV-to-SV (to enable or disable ISLs) or between SV-Earth (to enable or disable geographic coverage)). The definition of exclusion zones with routing information increases efficiency of constellation, especially for form-flying constellations (e.g., similar to Iridium, Starlink, and the like).

In an example, exclusion zones can be calculated and provided with orbit and ISL connectivity alignment information. Thus, LEO SVs can be instructed to implement exclusion zones, when receiving instructions to adjust orbital position. Such instructions may include turning various ISL connections on and off, adjusting right, left, fore and aft antennas (regardless or implementation type), if a scenario is projected where an ISL is interfering with a higher-orbit satellite communication (or vice versa). Other considerations established with these exclusion zones may include routing that considers ground and space nodes, including EZs implemented at the same time (whether SV-to-SV or SV-earth exclusion zones), while increasing the efficiency of a constellation. These EZs may also consider that form-flying ISLs antennas often require (1) beam steering, (2) high directivity, and (3) longer ranges and larger apertures than free flying swarm constellations.

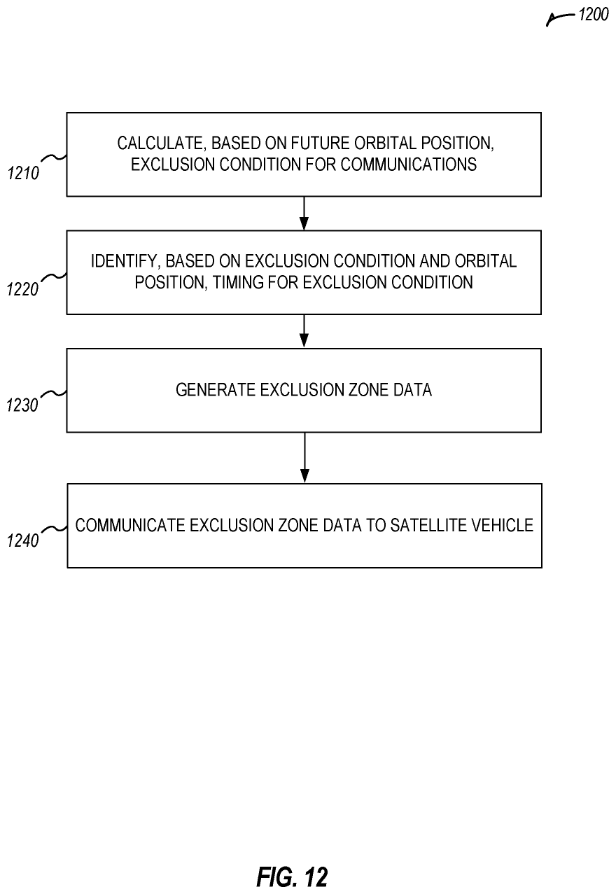

FIG. 12 illustrates a flowchart of an example method 1200 of defining and communicating exclusion zones.

The method begins, at operation 1210, to calculate, based on a future orbital position of a low-earth orbit satellite vehicle, an exclusion condition for communications from the satellite vehicle.

The method continues, at operation 1220, to identify, based on the exclusion condition and the future orbital position, a timing for implementing the exclusion condition for the communications from the satellite vehicle.

The method continues, at operation 1230, to generate exclusion zone data for use by the satellite vehicle. In an example, the exclusion zone data indicates the timing for implementing the exclusion condition for the communications from the satellite vehicle.

The method completes, at operation 1240, to cause communication of the exclusion zone data to the satellite vehicle. In an example, the operations of the method 1200 are performed by a ground-based data processing server at a regular interval, and this communication occurs from the ground-based data processing server to the satellite vehicle. In further examples, the operations of the method 1200 are performed at least in part using computing hardware of the satellite vehicle.

In an example, the exclusion condition of method 1200 is an exclusion of use of a communication frequency onto a terrestrial geographic area. For instance, the exclusion zone data may further identify the communication frequency, and implementation of the exclusion zone data at the satellite vehicle causes the satellite vehicle to discontinue use of the communication frequency while in communication range over the terrestrial geographic area.

In an example, the exclusion condition of method 1200 is an exclusion of use of a spot beam onto a terrestrial geographic area, and the exclusion zone data further identifies the spot beam of the satellite vehicle, as implementation of the exclusion zone data at the satellite vehicle causes the satellite vehicle to discontinue use of the spot beam while in communication range over the terrestrial geographic area.

In an example, the exclusion condition of method 1200 is an exclusion of use of an inter-satellite link from the satellite vehicle, and the exclusion condition is based on the future orbital position overlapping with communications from another satellite vehicle. For instance, the inter-satellite link may be defined based on a fore, aft, right, or left direction from the satellite vehicle.

In an example, the exclusion condition of method 1200 is an exclusion of use of a cellular network coverage at a geographic area, and implementation of the exclusion zone data at the satellite vehicle causes the satellite vehicle to communicate a command to connected user equipment to discontinue use of a satellite network connection while the satellite vehicle is in communication range of the cellular network coverage at the geographic area.

In an example, the exclusion zone data of method 1200 is communicated to the satellite vehicle with a routing table, as the routing table operates to control the future orbital position of the satellite vehicle. In other examples, aspects of a routing protocol, routing protocol data, routing data, or configuration data (e.g., in a particular format) for routing and routing settings may be communicated. In a further example, the exclusion zone data includes attestation or authentication information for verification by the satellite vehicle. Additionally, in a further example, the exclusion zone data may be designated and used by a plurality of satellite vehicles in a constellation including the satellite vehicle.

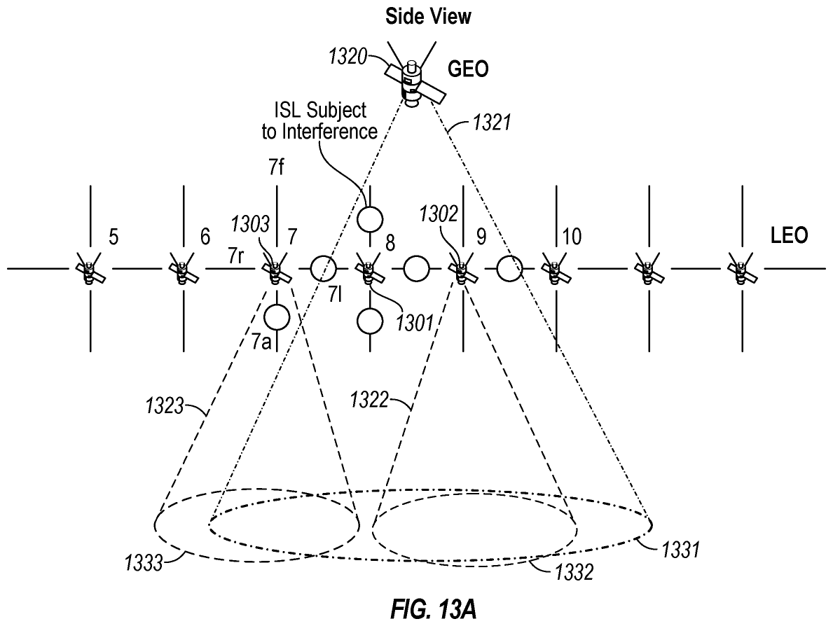

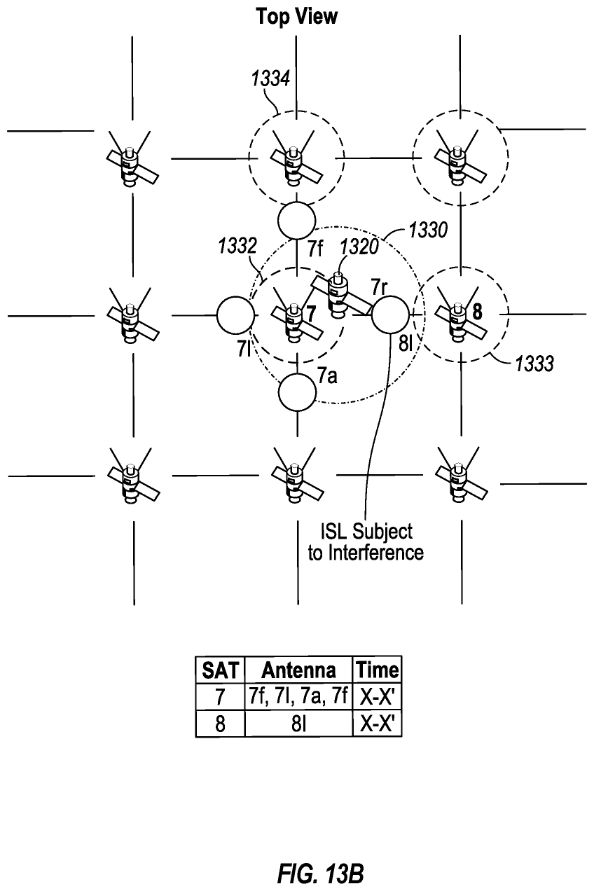

FIGS. 13A and 13B illustrate side and top views, respectively, of an example interference scenario in inter-satellite communications of a non-terrestrial communication network. As shown, a GEO satellite 1320 provides a beam coverage 1321 at a geographic area 1331. LEO satellites 7 (1303), 8 (1301), and 9 (1302) provide coverage that overlaps the geographic area 1331 at least in part, shown with LEO spot beam 1323 from satellite 7 1303, and LEO spot beam 1322 from satellite 9 1302.

Among LEO satellites 1301, 1302, 1303, a number of inter-satellite connections (ISLs) exist, in right, left, fore, and aft directions. This is demonstrated from a top view in FIG. 13B, where satellite 7 1303 and satellite 8 1301 use ISLs to communicate with each other and a number of other satellites in the constellation. In response to determining that the GEO satellite 1320 will encounter interference with intersatellite links within the coverage of its beam 1330 (at the LEO altitude), relevant ISLs which potentially interfere with the beam can be disabled.

A designation of beams, or specific frequency in links, to disable is shown in FIG. 13B, where all ISLs with satellite 7 1302 are turned off (due to satellite 7 1302 being located entirely within the coverage of area 1330), in the fore, aft, left, and right locations; whereas only the left communication between satellite 7 1302 and satellite 8 1301 is disabled.

The use of exclusion zones can be implemented in simple or complex terms, including simple methods to turn the antennas (and communication paths) off to reduce interference. This provides a method of imposing organic exclusion zones for constellation routing, and reduces wear and tear on network and network processing.

In an example, a service provider can initiate an interference mitigation exclusion zone, by communicating relevant parameters discussed in the examples below (e.g., EZ.id, EZ.name, EZ.ground, EZ.ground.radius, EZ.ground.lat, EZ.ground.long, EZ.ground.IP, EZ.ground.GPS, EZ.min.intensity). For example, such parameters may specify an ID (e.g., satellite identifier), and the characteristics of when an exclusion zone should be in operation (e.g., when operating over a ground latitude and longitude at 111 degrees meridian west). A system implementing an exclusion zone also may obtain future SV (fly-over) positions relative to a ground location. The response provided from a footprint command (e.g., Get SV Footprint, discussed below), may provide information to determine an expected response from fly-over telemetry (readily available via NORAD or from a constellation provider).

To prevent interference based on inter-satellite links, a calculation of the exclusion zone may evaluate: (1) Does SV.n.fly-over overlap/intercept with EZ.n.area? (2) If there is overlap of the area, does SV.min.intensity>EZ.min.intensity? (3) If Yes, then prepare to turn-off (or, lower intensity in accordance with a service provider agreement, regulations, etc.) the SV beams, links, or specific frequencies within beams or links by using an appropriate command (e.g., Set SV EZ command).

In an example, a Set SV EZ command may be defined to include the following parameters to control inter-satellite communication links:

TABLE 4

| Parameter | Type | Comments |
|---|---|---|
| SV.EZ.fore | Int | On/off based on interference |
| SV.EZ.aft | Int | On/off based on interference |
| SV.EZ.right | Int | On/off based on interference |
| SV.EZ.left | Int | On/off based on interference |

In an example, with no interference, SV.EZ.fore, SV.EZ.aft, SV.EZ.right, and SV.EZ.left, are set to “on”. In an example, with calculated interference from other satellites, one or more of these values (e.g., SV.EZ.aft, SV.EZ.right, SV.EZ.left) are set to “off”, while zero or more of the values (e.g., “SV.EZ.fore”) are set to “on”. Thus, in scenarios where GEO and LEO deployments are overlapping via the LEO ISLs, the capability of turning on and off a link in a particular direction may immediately remedy any possible interference.

EZs can also be defined to address potential interference concerns related to potential competitive LEO constellations or even for the same constellation in the different orbital planes. Thus, an exclusion zone may be defined to apply to particular frequency bands, or whatever frequency (e.g., to disable all ISLs of LEOs that fly under the GEO, or that have a potential of disruption based on other GEO, MEO, or LEDs).

In further examples, the consideration of interference or possible disruption, and the use of EZs, may be based on a service provider policy. For example, a LEO provider which operates a premium service using ISLs, may disable or adapt aspects of the ISLs based on any possibility of disruption or interference (e.g., relying on ISL routing through other paths).

Accordingly, any of the examples of EZs may be implemented and determined based on inter-constellation interference or disruption (e.g., within the same constellation), from other satellites or constellations (e.g., within different satellite altitudes) in the same or different orbital plane, or for policy considerations (e.g., to guarantee premium routing services do not encounter disruption). Other variation for the control, definition, and use of exclusion zones (and controls of frequency bands or types of communications within an exclusion zone) may also be provided.

Comparison of Exclusion Zone Commands and Techniques

As will be understood, standard EZ Descriptions (and Language) can be shared across Terrestrial/Non-Terrestrial Service Providers for consistency and coordination among multiple-5G Terrestrial and geostationary/non-geostationary orbit (NGO) solutions. Implementations of EZs within separate Constellation Providers may vary but EZ Descriptions for ground-based keep-out areas may be sharable across Service Providers, including Cloud and Telecommunication Service Providers. In general, standard “fixed” EZs descriptions can be used to formulate and influence routing and switching payloads to help Service Providers coordinate as the number of NTN satellites and systems increase.

In an example, various commands for exclusion zones may include commands to: Define EZ (to define exclusion zones), Get SV (to obtain SV orbital fly-by information), and Set EZ (to implement an EZ within a constellation). Such commands may be extended for use with constellations, with the following definitions (with “EZn” referring to an identifier of an nth EZ).

Define EZ (Define Exclusion Zone):

TABLE 5

| Parameter | Type | Description |
|---|---|---|
| EZn.ID | INT | EZ Unique ID |
| EZn.NAME | STRING | EZ Name |
| EZn.RADIUS | FLOAT | EZ Radius |
| | | for KEEP |
| | | OUT AREA |
| EZn.LAT.PT | FLOAT | EZ Latitude |
| | | Ground/Sky |
| | | Center Point for |
| | | KEEP OUT AREA |
| EZn.LONG.PT | FLOAT | EZ Longitude |
| | | Ground/Sky |
| | | Center Point for |
| | | KEEP OUT AREA |
| EZn.IP.PT | FLOAT | EZ IP Address |
| | | Ground/Sky |
| | | Center Point for |
| | | KEEP OUT AREA |
| EZn.GPS.PT | FLOAT | EZ GPS Ground/ |
| | | Sky Center |
| | | Point for |
| | | KEEP OUT AREA |
| EZn.MIN.INTENSITY.THRESHOLD | FLOAT | EZ Min Ground/ |
| | | Sky Center Point |
| | | Spot Beam/Freq |
| | | Intensity Threshold |
| EZn.MAX.INTENSITY.THRESHOLD | FLOAT | EZ Max Ground/ |
| | | Sky Center Point |
| | | Spot Beam/Freq |
| | | Intensity Threshold |
| EZn.ISL.TOGGLE | ON/ | EZ Intersatellite |
| | OFF | Link (ISL) |
| | | ON or OFF |
| EZn.LRM.TOGGLE | ON/ | EZ Light Reflection |
| | OFF | Mitigation |
| | | (LRM) ON or OFF |
| EZn.SPOT.TOGGLE | ON/ | EZ Spot |
| | OFF | Beam (SPOT) |
| | | ON or OFF |
| EZn.Terrestrial | AI | Could impact |
| Measurements | | terrestrial controls |
| EZn.Satellite | AI | Could impact |
| Measurements | | satellite controls |

Get SV (Get SV Orbital “fly-by” information):

TABLE 6

| Parameter | Type | Description |
|---|---|---|
| SVn.ID.International | STRING | International Designator |
| SVn.ID.NORAD | INT | NORAD Catalog Number |
| SVn.ID.NAME | STRING | SV Name |
| SVn.GND.lat | FLOAT | Ground location latitude |
| | | for SV fly-over |
| SVn.GND.long | FLOAT | Ground location longitude |
| | | for SV fly-over |
| SVn.GND.alt | FLOAT | Ground location altitude % for |
| | | intensity threshold calculations |
| SVn.GND.time | INT | Amount of time to obtain |
| | | SV flyover(s) |
| SVn.Period | Minutes | Location Minutes |
| SVn.Inclination | Degrees | Location Inclination |
| SVn.Apogee. Height | KM | Location Apogee |
| SVn.Perigee.Height | KM | Location Perigee |
| SVn.Eccentricity | FLOAT | Location Eccentricity |

Set EZ (Implement EZ within Constellation):

TABLE 7

| Parameter | Type | Description |
|---|---|---|
| SVn.ID.International | STRING | International Designator |
| SVn.ID.NORAD | INT | NORAD Catalog Number |
| SVn.ID.NAME | STRING | SV Name |
| SVn.SPOTn.TOGGLE | ON/ | SV Spot Beam n Downlink UTC TIME |
| | OFF | START/STOP |
| SVn.SPOTn.FREQn.TOGGLE | ON/ | SV Spot Beam n Frequency n Downlink |
| | OFF | UTC TIME START/STOP |
| SVn.ISL.FORE.TOGGLE | ON/ | SV Intersatellite Link UTC TIME |
| | OFF | START/STOP |
| SVn.ISL.AFT.TOGGLE | ON/ | SV Intersatellite Link UTC TIME |
| | OFF | START/STOP |
| SVn.ISL.RIGHT.TOGGLE | ON/ | SV Intersatellite Link UTC TIME |
| | OFF | START/STOP |
| SVn.ISL.LEFT.TOGGLE | ON/ | SV Intersatellite Link UTC TIME |
| | OFF | START/STOP |
| SVn.SHADE.TOGGLE | ON/ | SV Reflection Shade UTC TIME |
| | OFF | START/STOP |
| SV.EZ.method | INT | ON/OFF or Intensity reduction (e.g., |
| | | based on service provider SLA) |

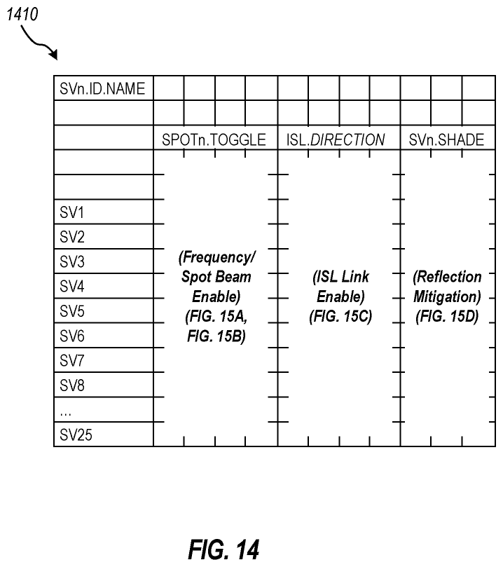

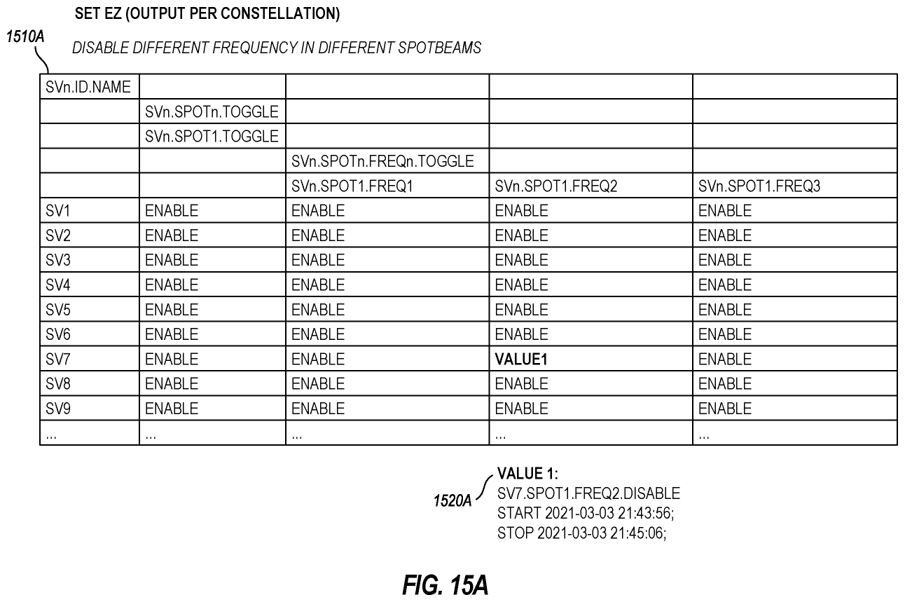

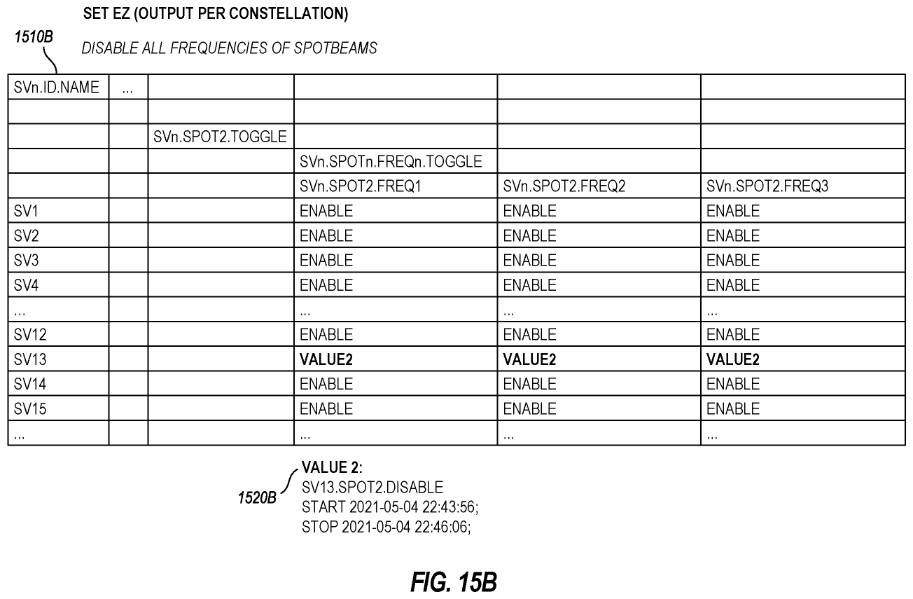

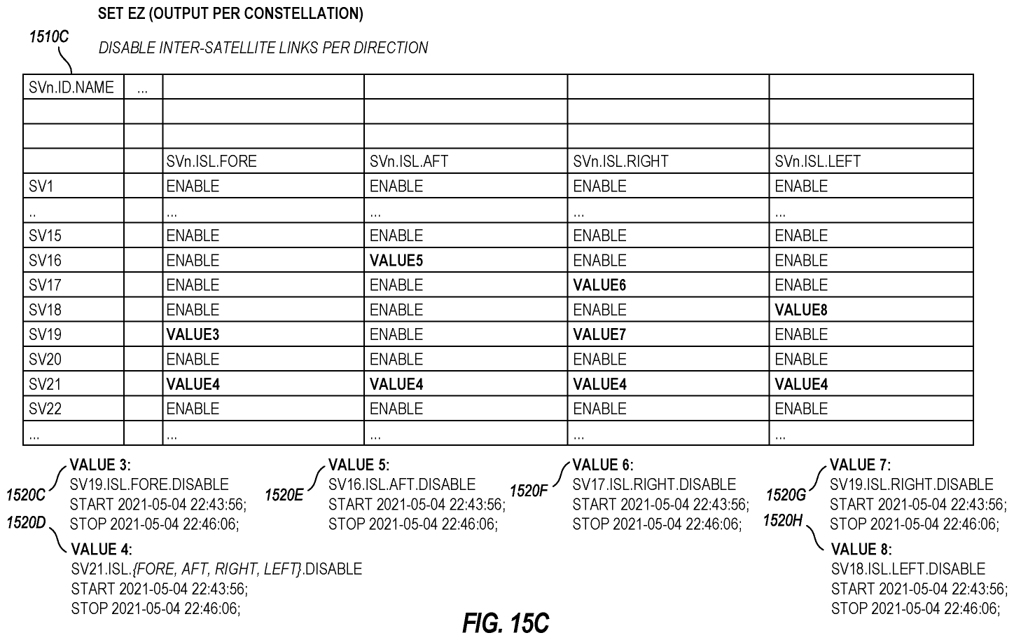

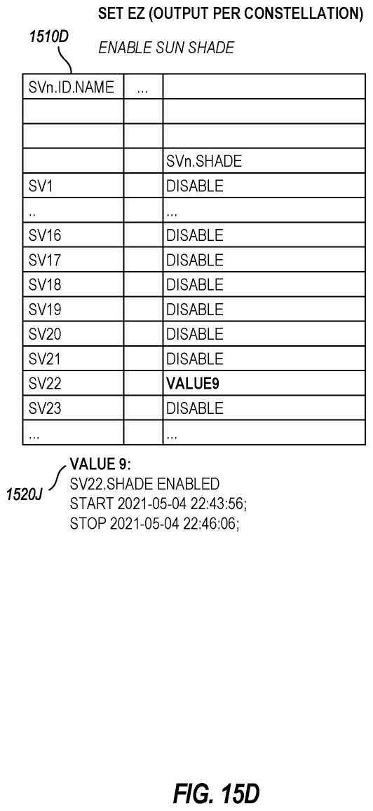

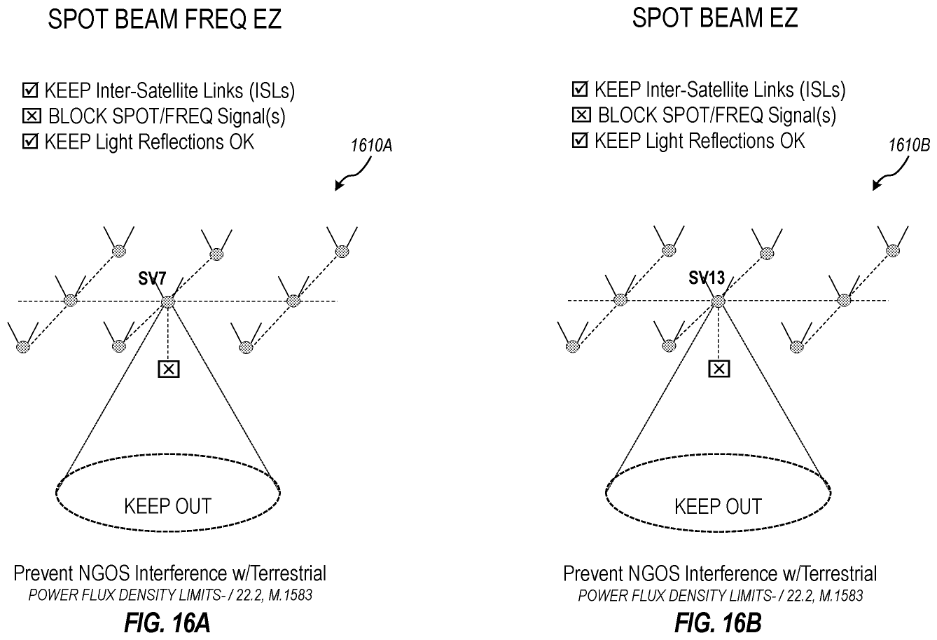

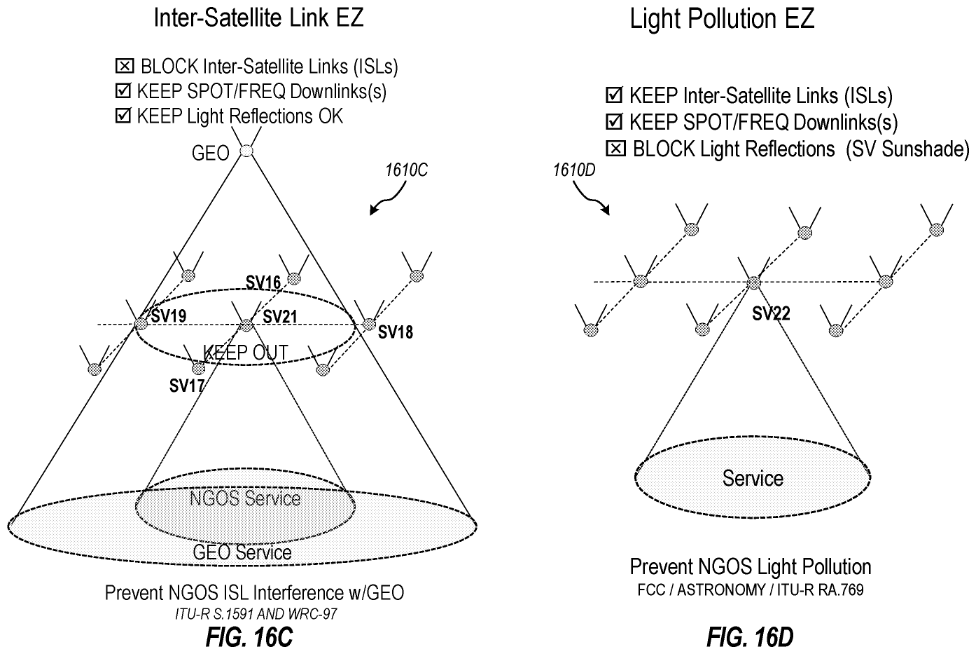

One configuration of an exclusion zone definition for multiple satellites of a constellation is depicted in a table 1410 of FIG. 14. Here, this drawing illustrates how different portions of a table or grid of data may allow definition of different values for different vehicles, on the basis of multiple exclusion zone types or characteristics. For example, a portion of this table 1410 may be used to define a toggle (disable/enable) value for a spot beam or a frequency within a spot beam, as described below with reference to FIGS. 16A and 16B and defined within the tables of FIGS. 15A and 15B. Another portion of this table 1410 may be used to define a toggle (disable/enable) value for inter-satellite links, including different communication directions for the links, as described below with reference to FIG. 16C and defined within the table of FIG. 15C. Finally, another portion of this table 1410 may be used to define a reflection mitigation control, as described below with reference to FIG. 16D and defined within the table of FIG. 15D. This data format and table format is provided only for purposes of illustration; many other data representations, definitions, and formats may be used to communicate or represent exclusion zone data.

FIG. 16A illustrates further views of an example interference scenario 1610A over a geographic area, and the use of spot beam frequency exclusion zones to implement a keep-out area from SV7. Here, the intent of the EZ is to block specific signals from radiating on the ground, such as where different countries or geographical areas impose different intensity limits. For instance, to implement this exclusion zone based on frequency, values such as the following may be established via the following Define EZ (TABLE 8), Get SV (TABLE 9), and Set EZ (TABLE 10) commands

TABLE 8
Define EZ (Input)

| Parameter | Value |
|---|---|
| EZn.ID | EZ22.12345 |
| EZn.NAME | EZ22.AZ_GND_STATION_KO |
| EZn.RADIUS | 100 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 9
Get SV (input)

| Parameter | Value |
|---|---|
| SVn.ID.International | 2019-029BD |
| SVn.ID.NORAD | 44286 |
| SVn.ID.NAME | SV7 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 10
Set EZ (Output per SV) (Disable frequencies
in respective spotbeams)

| Parameter | Value |
|---|---|
| SVn.ID.International | 2019-029BD |
| SVn.ID.NORAD | 44286 |
| SVn.ID.NAME | SV7 |
| SVn.SPOTn.TOGGLE | ON |
| SVn.SPOTn.FREQn.TOGGLE | SV7.SPOT1.FREQ2.DISABLE |
| | START 2021-03-03 21:43:56; |
| | STOP 2021-03-03 21:45:06; |
| SVn.ISL.FORE.TOGGLE | ON |
| SVn.ISL.AFT.TOGGLE | ON |
| SVn.ISL.RIGHT.TOGGLE | ON |
| SVn.ISL.LEFT.TOGGLE | ON |
| SVn.SHADE.TOGGLE | ON |
| SV.EZ.method | ON >15% |

A detailed charting of a subset of SET EZ values to disable a particular spot beam frequency is shown in table 1510A of FIG. 15A, where a value 1520A to disable a particular spot beam of a particular satellite vehicle at a particular time (and for a particular duration) is communicated.

FIG. 16B illustrates further views of an example interference scenario 1610B over a geographic area, and the use of combined spot beam frequency exclusion zones to implement a keep-out area of all frequencies from a spot beam of SV13. For instance, to implement this exclusion zone for an entire spot beam, values such as the following may be established via the following Define EZ (TABLE 11), Get SV (TABLE 12), and Set EZ (TABLE 13) commands

TABLE 11
Define EZ (Input)

| Parameter | Value |
|---|---|
| EZn.ID | EZ22.12345 |
| EZn.NAME | EZ22.AZ_GND_STATION_KO |
| EZn.RADIUS | 100 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 12
Get SV (Input)

| Parameter | Value |
|---|---|
| SVn.ID.International | 2019-029BD |
| SVn.ID.NORAD | 44286 |
| SVn.ID.NAME | SV13 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 13
Set EZ (Output per SV) (To disable respective spotbeams)

| Parameter | Value |
|---|---|
| SVn.ID.International | 2019-029BD |
| SVn.ID.NORAD | 44286 |
| SVn.ID.NAME | SV13 |
| SVn.SPOTn.TOGGLE | SV13.SPOT2.DISABLE |
| | START 2021-05-04 22:43:56; |
| | STOP 2021-05-04 22:46:06; |
| SVn.SPOTn.FREQn.TOGGLE | OFF |
| SVn.ISL.FORE.TOGGLE | ON |
| SVn.ISL.AFT.TOGGLE | ON |
| SVn.ISL.RIGHT.TOGGLE | ON |
| SVn.ISL.LEFT.TOGGLE | ON |
| SVn.SHADE.TOGGLE | ON |
| SV.EZ.method | OFF |

A detailed charting of a subset of SET EZ values to disable an entire spot beam is shown in table 1510B of FIG. 15B, where a value 1520B to disable a particular spot beam of a particular satellite vehicle at a particular time (and for a particular duration) is communicated.

It will be understood that other variations to the approaches of FIGS. 16A and 16B may be implemented with EZs to block transmissions onto defined areas in connection with SCS communications and on-ground TN regulations. For instance, such exclusion zones may provide permutations of a spot beam block, a frequency block within a beam, or an “ignore” setting when the intensity of the spot beam is below the intensity of allowance in the keep out zone.

FIG. 16C illustrates further views of an example interference scenario 1610C in inter-satellite communications of a non-terrestrial communication network. Depending on orbit positions, altitude, type of interference, and other characteristics, it is possible that some directions of communications (e.g., between satellite SV21 and SV19) will be determined to interfere or experience interference, whereas communications in a different direction (e.g., between satellite SV19 and other satellites) will not interfere or experience interference with higher-altitude satellite communications.

To implement an exclusion zone for control of inter-satellite links, values such as the following may be established for an exclusion zone involving SV21 of FIG. 16C via the following Define EZ (TABLE 14), Get SV (TABLE 15), and Set EZ (TABLE 16) commands

TABLE 14
Define EZ (Input) (For Inter-Satellite Links)

| Parameter | Value |
|---|---|
| EZn.ID | EZ22.12345 |
| EZn.NAME | EZ22.AZ_GEO_KO |
| EZn.RADIUS | 2000 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 15
Get SV (input)

| Parameter | Value |
|---|---|
| SVn.ID.International | 2019-029BD |
| SVn.ID.NORAD | 44286 |
| SVn.ID.NAME | SV21 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 16
Set EZ (Output per SV) (Disable impacted ISLs)

| Parameter | Value |
|---|---|
| SVn.ID.International | 2019-029BD |
| SVn.ID.NORAD | 44286 |
| SVn.ID.NAME | SV21 |
| SVn.SPOTn.TOGGLE | |
| SVn.SPOTn.FREQn.TOGGLE | ON |
| SVn.ISL.FORE.TOGGLE | SV21.ISL.FORE.DISABLE |
| | START 2021-05-04 22:43:56; |
| | STOP 2021-05-04 22:46:06; |
| SVn.ISL.AFT.TOGGLE | SV21.ISL.AFT.DISABLE |
| | START 2021-05-04 22:43:56; |
| | STOP 2021-05-04 22:46:06; |
| SVn.ISL.RIGHT.TOGGLE | SV21.ISL.RIGHT.DISABLE |
| | START 2021-05-04 22:43:56; |
| | STOP 2021-05-04 22:46:06; |
| SVn.ISL.LEFT.TOGGLE | SV21.ISL.LEFT.DISABLE |
| | START 2021-05-04 22:43:56; |
| | STOP 2021-05-04 22:46:06; |
| SVn.SHADE.TOGGLE | ON |
| SV.EZ.method | OFF |

As shown in FIG. 16C, the EZ for ISLs is defined relative to the GEO coverage area. A detailed charting of SET EZ values to disable ISLs is shown in FIG. 15C, such as value 1520D for SV21 to indicate a time and direction to disable ISLs of SV21 from FIG. 16C. To implement an exclusion zone for control of inter-satellite links for SV20, SV18, SV17, SV16, to meet the scenario shown in FIG. 16C, the Get SV SVn.ID.NAME and Set EZ SVn.ID.NAME values would substitute “SV21” with the respective “SV20”, “SV18”, “SV17”, “SV16” values, and the Set EZ SV.ISL.FORE, .AFT, .LEFT, .RIGHT toggle values would substitute with values relevant to the respective SVs (values 1520C, 1520E, 1520F, 1520G, 1520H in FIG. 15C).

FIG. 16D illustrates further views of an example light pollution scenario 1610D based on reflections from individual SVs of a non-terrestrial communication network. To implement an exclusion zone for control of SV mechanisms to mitigate light reflections, values such as the following may be established for an exclusion zone involving SV22 of FIG. 16D via the following Define EZ (TABLE 17), Get SV (TABLE 18), and Set EZ (TABLE 19) commands .

TABLE 17
Define EZ (Input) (For SV Light Pollution Shading)

| Parameter | Value |
|---|---|
| EZn.ID | EZ22.12345 |
| EZn.NAME | EZ22.AZ_ASTRO |
| EZn.RADIUS | 50 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 18
Get SV (input)

| Parameter | Value |
|---|---|
| SVn.ID.International | 2019-029BD |
| SVn.ID.NORAD | 44333 |
| SVn.ID.NAME | SV22 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 19
Set EZ (Output per SV) (Shade SV)

| Parameter | Value |
|---|---|
| SVn.ID.International | 2019-029BD |
| SVn.ID.NORAD | 44333 |
| SVn.ID.NAME | SV22 |
| SVn.SPOTn.TOGGLE | |
| SVn.SPOTn.FREQn.TOGGLE | ON |
| SVn.ISL.FORE.TOGGLE | ON |
| SVn.ISL.AFT.TOGGLE | ON |
| SVn.ISL.RIGHT.TOGGLE | ON |
| SVn.ISL.LEFT.TOGGLE | ON |
| SVn.SHADE.TOGGLE | SV22.SHADE ENABLED |
| | START 2021-05-04 22:43:56; |
| | STOP 2021-05-04 22:46:06; |
| SV.EZ.method | OFF |

A detailed charting of a subset of SET EZ values to enable (toggle) a shade or light reflection feature is shown in table 1510D of FIG. 15D, where a value 1520J to enable a sunshade of a particular satellite vehicle at a particular time (and for a particular duration) is communicated.

Other permutations of the previously described EZs may include establishing borders or zones between different LEO constellations, such as to prevent LEO constellations from different service provides from talking with one another. Likewise, other permutations may involve cooperation between constellations to enable or restrict aspects of “roaming” or accessing services offered from other service providers, network companies, or countries.

Similar to above, specific commands and values to define a SCS Zone to define characteristics of an EZ or IZ for use with SCS operations (e.g., as discussed with reference to FIGS. 3 to 5) may include the following:

TABLE 20
Set SCS Zone (Input)

| Parameter | Type | Description |
|---|---|---|
| SCS_ZONEn.ID | INT | SCS_ZONE Unique ID |
| SCS_ZONEn.NAME | STRING | SCS_ZONE Name |
| SCS_ZONEn.RADIUS | FLOAT | SCS_ZONE Radius for KEEP |
| | | OUT AREA |
| SCS_ZONEn.LAT.PT | FLOAT | SCS_ZONE Latitude |
| | | Ground/Sky Center Point for |
| | | KEEP OUT AREA |
| SCS_ZONEn.LONG.PT | FLOAT | SCS_ZONE Longitude |
| | | Ground/Sky Center Point for |
| | | KEEP OUT AREA |
| SCS_ZONEn.IP.PT | FLOAT | SCS_ZONE IP Address |
| | | Ground/Sky Center Point for |
| | | KEEP OUT AREA |
| SCS_ZONEn.GPS.PT | FLOAT | SCS_ZONE GPS Ground/Sky |
| | | Center Point for KEEP OUT |
| | | AREA |
| SCS_ZONEn.MIN.FREQBAND.THRESHOLD | FLOAT | SCS_ZONE disallowed Freq |
| | | Band MIN Range |
| SCS_ZONEn.MAX.FREQBAND.THRESHOLD | FLOAT | SCS_ZONE disallowed Freq |
| | | Band MAX Range |
| SCS_ZONEn.MIN.INTENSITY.THRESHOLD | FLOAT | SCS_ZONE Min Ground/Sky |
| | | Center Point Spot Beam/ |
| | | Intensity Threshold |
| SCS_ZONEn.MAX.INTENSITY.THRESHOLD | FLOAT | SCS_ZONE Max Ground/Sky |
| | | Center Point Spot Beam/ |
| | | Intensity Threshold |
| SCS_ZONEn.ISL.TOGGLE | ON/OFF | SCS_ZONE Intersatellite Link |
| | | (ISL) ON or OFF |
| SCS_ZONEn.LRM.TOGGLE | ON/OFF | SCS_ZONE Light Reflection |
| | | Mitigation (LRM) ON or OFF |
| SCS_ZONEn.SPOT.TOGGLE | ON/OFF | SCS_ZONE Spot Beam (SPOT) |
| | | ON or OFF |
| SCS_ZONEn.BER | | Bit Error Rate |
| SCS_ZONEn.SNR | | Signal to Noise Ratio |
| SCS_ZONEn.CNR | | Carrier to Noise Ratio |
| SCS_ZONEn.PFD | | Power Flux Density |
| SCS_ZONEn.RIP | | Received isotropic power |
| SCS_ZONEn.EIRP | | Effective isotropic radiated |
| | | power |
| SCS_ZONEn.AG | | Antenna Gain |
| SCS_ZONEn.Proximity | | Debris and or other Proximity |
| Constraint | | Alerts or Keep Outs (including |
| | | geographic keep-out areas) |

TABLE 21
Apply SCS Zone (Output)

| Parameter | Type | Description |
|---|---|---|
| SVn.ID.International | STRING | International Designator |
| SVn.ID.NORAD | INT | NORAD Catalog Number |
| SVn.ID.NAME | STRING | SV Name |
| SVn.SPOTn.TOGGLE | ON/OFF | SV Spot Beam n Downlink UTC |
| | | TIME START/STOP |
| SVn.SPOTn.FREQn.TOGGLE | ON/OFF | SV Spot Beam n Frequency n |
| | | Downlink UTC TIME |
| | | START/STOP |
| SVn.ISL.FORE.TOGGLE | ON/OFF | SV Intersatellite Link UTC TIME |
| | | START/STOP |
| SVn.ISL.AFT.TOGGLE | ON/OFF | SV Intersatellite Link UTC TIME |
| | | START/STOP |
| SVn.ISL.RIGHT.TOGGLE | ON/OFF | SV Intersatellite Link UTC TIME |
| | | START/STOP |
| SVn.ISL.LEFT.TOGGLE | ON/OFF | SV Intersatellite Link UTC TIME |
| | | START/STOP |
| SVn.SHADE.TOGGLE | ON/OFF | SV Reflection Shade UTC TIME |
| | | START/STOP |
| SV.SCS_ZONE.method | INT | ON/OFF or Intensity reduction |
| | | (e.g., based on service provider |
| | | SLA) |
| SVn.ID.International | STRING | International Designator |
| SVn.ID.NORAD | INT | NORAD Catalog Number |
| SVn.ID.NAME | STRING | SV Name |
| SVn.SPOTn.TOGGLE | ON/OFF | SV Spot Beam n Downlink UTC |
| | | TIME START/STOP |
| SVn.SPOTn.FREQn.TOGGLE | ON/OFF | SV Spot Beam n Frequency n |
| | | Downlink UTC TIME |
| | | START/STOP |
| SVn.ISL.FORE.TOGGLE | ON/OFF | SV Intersatellite Link UTC TIME |
| | | START/STOP |
| SVn.ISL.AFT.TOGGLE | ON/OFF | SV Intersatellite Link UTC TIME |
| | | START/STOP |

Other interference settings, measurements, or properties may be added, removed, or substituted for those specified in TABLE 20 and TABLE 21.

Similar approaches may be implemented for the definition and control of terrestrial network exclusion zones and ground stations. For instance, ground stations may coordinate TN coverage and operations based on interference measurements and conditions provided from NTN SCS communications.

Implementation in Edge Computing Scenarios

It will be understood that the present communication and networking arrangements may be integrated with many aspects of edge computing strategies and deployments. Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

In the context of satellite communication networks, edge computing operations may occur, as discussed above, by: moving workloads onto compute equipment at satellite vehicles; using satellite connections to offer backup or (redundant) links and connections to lower-latency services; coordinating workload processing operations at terrestrial access points or base stations; providing data and content via satellite networks; and the like. Thus, many of the same edge computing scenarios that are described below for mobile networks and mobile client devices are equally applicable when using a non-terrestrial network.

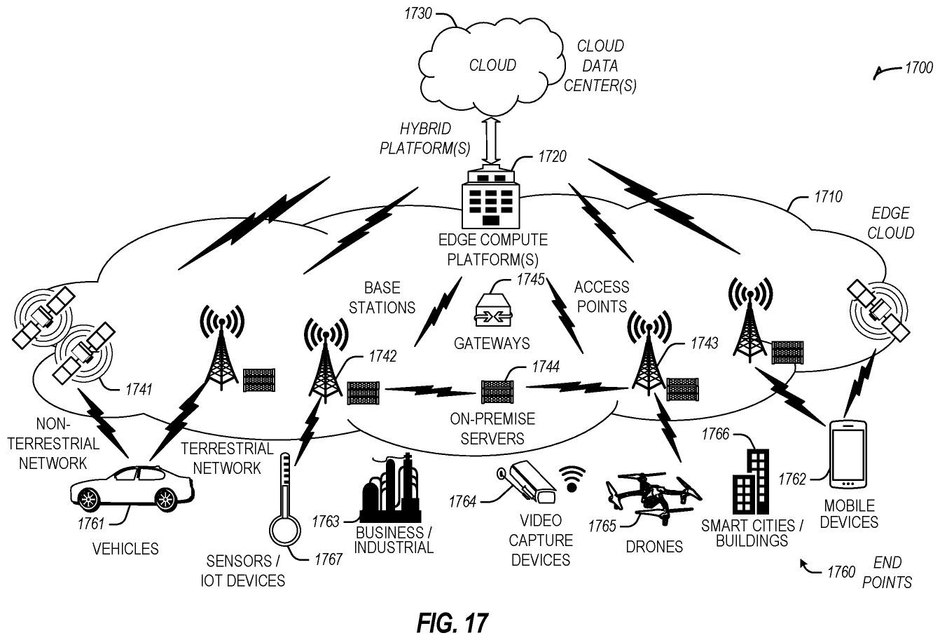

FIG. 17 is a block diagram 1700 showing an overview of a configuration for edge computing, which includes a layer of processing referenced in many of the current examples as an “edge cloud”. This network topology, which may include a number of conventional networking layers (including those not shown herein), may be extended through use of the satellite and non-terrestrial network communication arrangements discussed herein.

As shown, the edge cloud 1710 is co-located at an edge location, such as a satellite vehicle 1741, a base station 1742, a local processing hub 1750, or a central office 1720, and thus may include multiple entities, devices, and equipment instances. The edge cloud 1710 is located much closer to the endpoint (consumer and producer) data sources 1760 (e.g., autonomous vehicles 1761, user equipment 1762, business and industrial equipment 1763, video capture devices 1764, drones 1765, smart cities and building devices 1766, sensors and IoT devices 1767, etc.) than the cloud data center 1730. Compute, memory, and storage resources which are offered at the edges in the edge cloud 1710 are critical to providing ultra-low or improved latency response times for services and functions used by the endpoint data sources 1760 as well as reduce network backhaul traffic from the edge cloud 1710 toward cloud data center 1730 thus improving energy consumption and overall network usages among other benefits.

Compute, memory, and storage are scarce resources, and generally decrease depending on the edge location (e.g., fewer processing resources being available at consumer end point devices than at a base station or at a central office). However, the closer that the edge location is to the endpoint (e.g., UEs), the more that space and power is constrained. Thus, edge computing, as a general design principle, attempts to minimize the amount of resources needed for network services, through the distribution of more resources which are located closer both geographically and in network access time. In the scenario of non-terrestrial network, distance and latency may be far to and from the satellite, but data processing may be better accomplished at edge computing hardware in the satellite vehicle rather requiring additional data connections and network backhaul to and from the cloud.

In an example, an edge cloud architecture extends beyond typical deployment limitations to address restrictions that some network operators or service providers may have in their own infrastructures. These include, variation of configurations based on the edge location (because edges at a base station level, for instance, may have more constrained performance); configurations based on the type of compute, memory, storage, fabric, acceleration, or like resources available to edge locations, tiers of locations, or groups of locations; the service, security, and management and orchestration capabilities; and related objectives to achieve usability and performance of end services.

Edge computing is a developing paradigm where computing is performed at or closer to the “edge” of a network, typically through the use of a compute platform implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Likewise, within edge computing deployments, there may be scenarios in services which the compute resource will be “moved” to the data, as well as scenarios in which the data will be “moved” to the compute resource. Or as an example, base station (or satellite vehicle) compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 17, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, etc. and may fail in attempting to meet latency challenges. The extension of satellite capabilities within an edge computing network provides even more possible permutations of managing compute, data, bandwidth, resources, service levels, and the like.

Depending on the real-time requirements in a communications context, a hierarchical structure of data processing and storage nodes may be defined in an edge computing deployment involving satellite connectivity. For example, such a deployment may include local ultra-low-latency processing, regional storage and processing as well as remote cloud data-center based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud data-center.

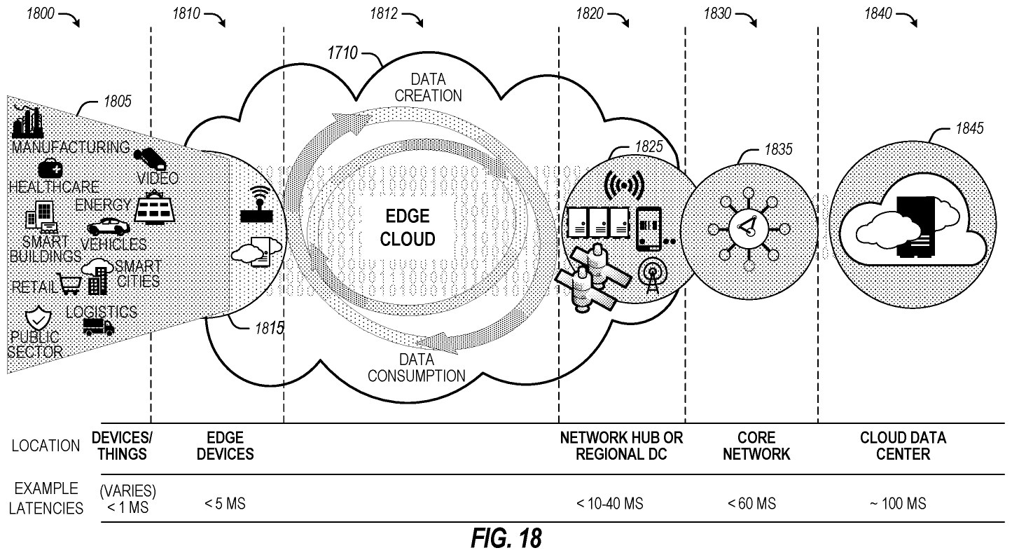

FIG. 18 illustrates operational layers among endpoints, an edge cloud, and cloud computing environments. Specifically, FIG. 18 depicts examples of computational use cases 1805, utilizing the edge cloud 1710 among multiple illustrative layers of network computing. The layers begin at an endpoint (devices and things) layer 1800, which accesses the edge cloud 1710 to conduct data creation, analysis, and data consumption activities. The edge cloud 1710 may span multiple network layers, such as an edge devices layer 1810 having gateways, on-premise servers, or network equipment (nodes 1815) located in physically proximate edge systems; a network access layer 1820, encompassing base stations, radio processing units, network hubs, regional data centers (DC), or local network equipment (equipment 1825); and any equipment, devices, or nodes located therebetween (in layer 1812, not illustrated in detail). The network communications within the edge cloud 1710 and among the various layers may occur via any number of wired or wireless mediums, including via connectivity architectures and technologies not depicted.

Examples of latency with terrestrial networks, resulting from network communication distance and processing time constraints, may range from less than a millisecond (ms) when among the endpoint layer 1800, under 5 ms at the edge devices layer 1810, to even between 10 to 40 ms when communicating with nodes at the network access layer 1820. (Variation to these latencies is expected with use of non-terrestrial networks). Beyond the edge cloud 1710 are core network 1830 and cloud data center 1840 layers, each with increasing latency (e.g., between 50-60 ms at the core network layer 1830, to 100 or more ms at the cloud data center layer). As a result, operations at a core network data center 1835 or a cloud data center 1845, with latencies of at least 50 to 100 ms or more, will not be able to accomplish many time-critical functions of the use cases 1805. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1835 or a cloud data center 1845, a central office or content data network may be considered as being located within a “near edge” layer (“near” to the cloud, having high latency values when communicating with the devices and endpoints of the use cases 1805), whereas an access point, base station, on-premise server, or network gateway may be considered as located within a “far edge” layer (“far” from the cloud, having low latency values when communicating with the devices and endpoints of the use cases 1805). It will be understood that other categorizations of a particular network layer as constituting a “close”, “local”, “near”, “middle”, or “far” edge may be based on latency, distance, number of network hops, or other measurable characteristics, as measured from a source in any of the network layers 1800-1840.

The various use cases 1805 may access resources under usage pressure from incoming streams, due to multiple services utilizing the edge cloud. To achieve results with low latency, the services executed within the edge cloud 1710 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement processing operations to remediate.

Thus, with these variations and service features in mind, edge computing within the edge cloud 1710 may provide the ability to serve and respond to multiple applications of the use cases 1805 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), etc.), which cannot leverage conventional cloud computing due to latency or other limitations. This is especially relevant for applications which require connection via satellite, and the additional latency that trips via satellite would require to the cloud.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also used at edge locations that may be unmanned and may even need permissioned access (e.g., when housed in a third-party location). Such issues are magnified in the edge cloud 1710 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1710 (network layers 1800-1840), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, circuitry, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1710.

As such, the edge cloud 1710 is formed from network components and functional features operated by and within edge gateway nodes, edge aggregation nodes, or other edge compute nodes among network layers 1810-1830. The edge cloud 1710 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1710 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

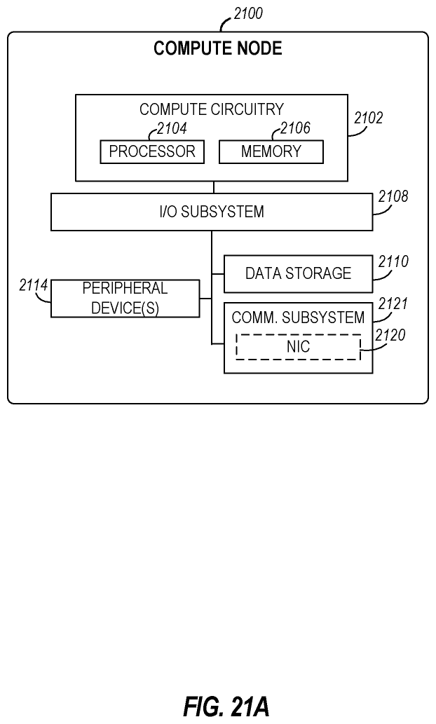

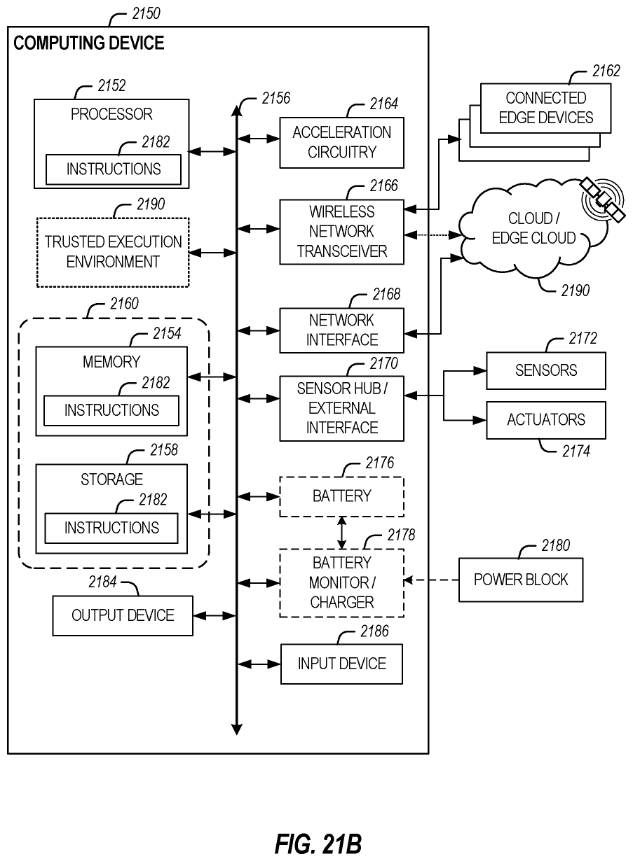

The network components of the edge cloud 1710 may be servers, multi-tenant servers, appliance computing devices, and/or any other type of computing devices. For example, a node of the edge cloud 1710 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 21B. The edge cloud 1710 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

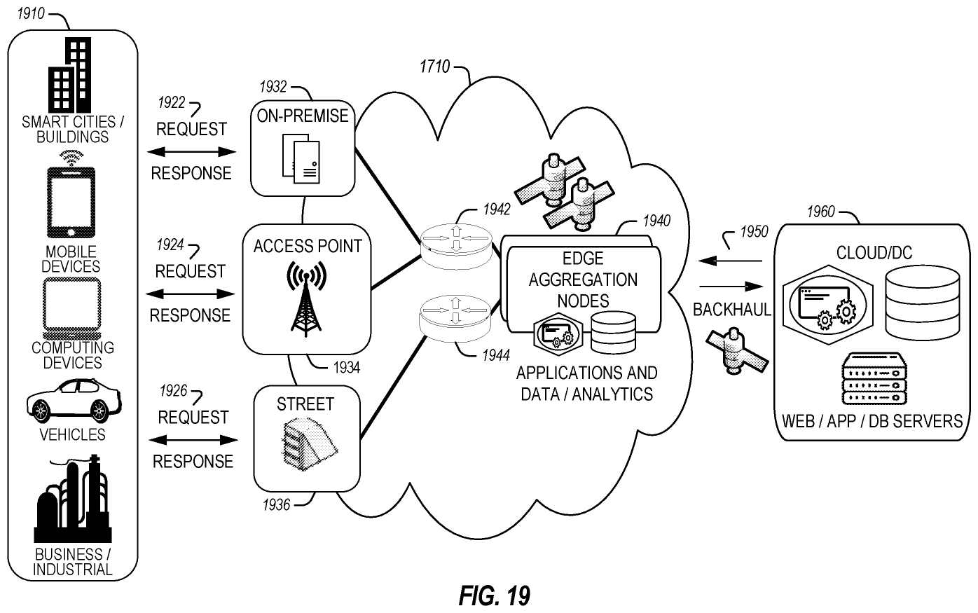

In FIG. 19, various client endpoints 1910 (in the form of mobile devices, computers, autonomous vehicles, business computing equipment, industrial processing equipment) exchange requests and responses that are specific to the type of endpoint network aggregation. For instance, client endpoints 1910 may obtain network access via a wired broadband network, by exchanging requests and responses 1922 through an on-premise network system 1932. Some client endpoints 1910, such as mobile computing devices, may obtain network access via a wireless broadband network, by exchanging requests and responses 1924 through an access point (e.g., cellular network tower) 1934. Some client endpoints 1910, such as autonomous vehicles may obtain network access for requests and responses 1926 via a wireless vehicular network through a street-located network system 1936. However, regardless of the type of network access, the TSP may deploy aggregation points 1942, 1944 within the edge cloud 1710 to aggregate traffic and requests. Thus, within the edge cloud 1710, the TSP may deploy various compute and storage resources, such as at edge aggregation nodes 1940 (including those located at satellite vehicles), to provide requested content. The edge aggregation nodes 1940 and other systems of the edge cloud 1710 are connected to a cloud or data center 1960, which uses a backhaul network 1950 (such as a satellite backhaul) to fulfill higher-latency requests from a cloud/data center for websites, applications, database servers, etc. Additional or consolidated instances of the edge aggregation nodes 1940 and the aggregation points 1942, 1944, including those deployed on a single server framework, may also be present within the edge cloud 1710 or other areas of the TSP infrastructure.

At a more generic level, an edge computing system may be described to encompass any number of deployments operating in the edge cloud 1710, which provide coordination from client and distributed computing devices. FIG. 18 provides a further abstracted overview of layers of distributed compute deployed among an edge computing environment for purposes of illustration.

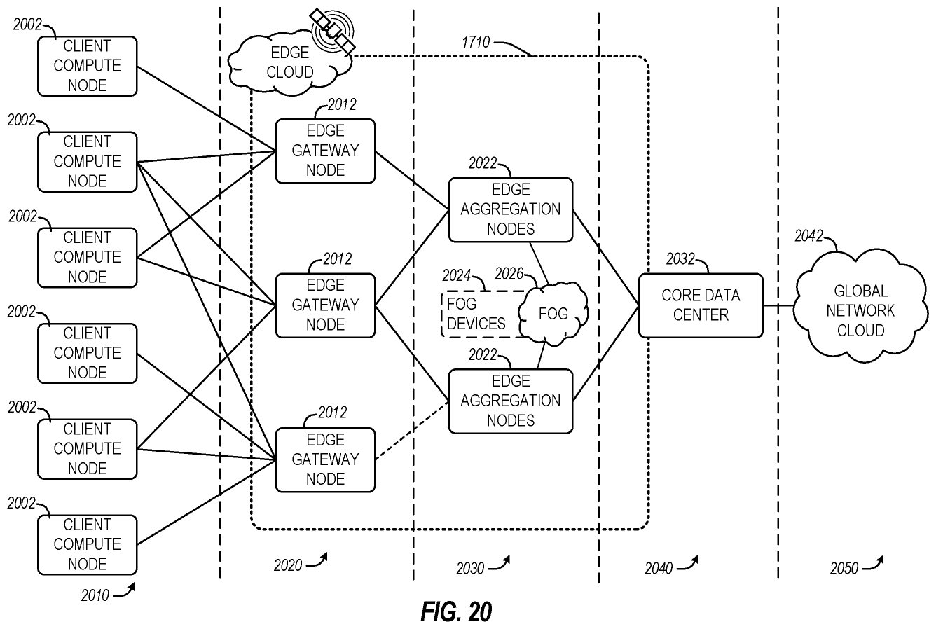

FIG. 20 generically depicts an edge computing system for providing edge services and applications to multi-stakeholder entities, as distributed among one or more client compute nodes 2002, one or more edge gateway nodes 2012, one or more edge aggregation nodes 2022, one or more core data centers 2032, and a global network cloud 2042, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 1800, 1810, 1820, 1830, 1840. For example, the client compute nodes 2002 are each located at an endpoint layer 1800, while each of the edge gateway nodes 2012 are located at an edge devices layer 1810 (local level) of the edge computing system. Additionally, each of the edge aggregation nodes 2022 (and/or fog devices 2024, if arranged or operated with or among a fog networking configuration 2026) are located at a network access layer 1820 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 2032 is located at a core network layer 1830 (e.g., a regional or geographically-central level), while the global network cloud 2042 is located at a cloud data center layer 1840 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 2032 may be located within, at, or near the edge cloud 1710.

Although an illustrative number of client compute nodes 2002, edge gateway nodes 2012, edge aggregation nodes 2022, core data centers 2032, global network clouds 2042 are shown in FIG. 20, it should be appreciated that the edge computing system may include more or fewer devices or systems at each layer. Additionally, as shown in FIG. 20, the number of components of each layer 1800, 1810, 1820, 1830, 1840 generally increases at each lower level (e.g., when moving closer to endpoints). As such, one edge gateway node 2012 may service multiple client compute nodes 2002, and one edge aggregation node 2022 may service multiple edge gateway nodes 2012.

Consistent with the examples provided herein, each client compute node 2002 may be embodied as any type of end point component, device, appliance, or “thing” capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1710.

As such, the edge cloud 1710 is formed from network components and functional features operated by and within the edge gateway nodes 2012 and the edge aggregation nodes 2022 of layers 1820, 1830, respectively. The edge cloud 1710 may be embodied as any type of network that provides edge computing and/or storage resources which are proximately located to radio access network (RAN) capable endpoint devices (e.g., mobile computing devices, IoT devices, smart devices, etc.), which are shown in FIG. 18 as the client compute nodes 2002. In other words, the edge cloud 1710 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 1710 may form a portion of or otherwise provide an ingress point into or across a fog networking configuration 2026 (e.g., a network of fog devices 2024, not shown in detail), which may be embodied as a system-level horizontal and distributed architecture that distributes resources and services to perform a specific function. For instance, a coordinated and distributed network of fog devices 2024 may perform computing, storage, control, or networking aspects in the context of an IoT system arrangement. Other networked, aggregated, and distributed functions may exist in the edge cloud 1710 between the cloud data center layer 1840 and the client endpoints (e.g., client compute nodes 2002). Some of these are discussed in the following sections in the context of network functions or service virtualization, including the use of virtual edges and virtual services which are orchestrated for multiple stakeholders.

The edge gateway nodes 2012 and the edge aggregation nodes 2022 cooperate to provide various edge services and security to the client compute nodes 2002. Furthermore, because each client compute node 2002 may be stationary or mobile, each edge gateway node 2012 may cooperate with other edge gateway devices to propagate presently provided edge services and security as the corresponding client compute node 2002 moves about a region. To do so, each of the edge gateway nodes 2012 and/or edge aggregation nodes 2022 may support multiple tenancy and multiple stakeholder configurations, in which services from (or hosted for) multiple service providers and multiple consumers may be supported and coordinated across a single or multiple compute devices.

In further examples, any of the compute nodes or devices discussed with reference to the present computing systems and environment may be fulfilled based on the components depicted in FIGS. 21A and 21B. Each compute node may be embodied as a type of device, appliance, computer, or other “thing” capable of communicating with other edge, networking, or endpoint components.

In the simplified example depicted in FIG. 21A, an edge compute node 2100 includes a compute engine (also referred to herein as “compute circuitry”) 2102, an input/output (I/O) subsystem 2108, data storage device 2110, communication circuitry 2112, and, optionally, one or more peripheral devices 2114. In other examples, each compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 2100 may be embodied as any type of engine, device, or collection of devices capable of performing various compute functions. In some examples, the compute node 2100 may be embodied as a single device such as an integrated circuit, an embedded system, a field-programmable gate array (FPGA), a system-on-a-chip (SOC), or other integrated system or device. In the illustrative example, the compute node 2100 includes or is embodied as a processor 2104 and a memory 2106. The processor 2104 may be embodied as any type of processor capable of performing the functions described herein (e.g., executing an application). For example, the processor 2104 may be embodied as a multi-core processor(s), a microcontroller, or other processor or processing/controlling circuit. In some examples, the processor 2104 may be embodied as, include, or be coupled to an FPGA, an application specific integrated circuit (ASIC), reconfigurable hardware or hardware circuitry, or other specialized hardware to facilitate performance of the functions described herein.

The main memory 2106 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory, other storage class memory), or other byte addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 2106 may be integrated into the processor 2104. The main memory 2106 may store various software and data used during operation such as one or more applications, data operated on by the application(s), libraries, and drivers.

The compute circuitry 2102 is communicatively coupled to other components of the compute node 2100 via the I/O subsystem 2108, which may be embodied as circuitry and/or components to facilitate input/output operations with the compute circuitry 2102 (e.g., with the processor 2104 and/or the main memory 2106) and other components of the compute circuitry 2102. For example, the I/O subsystem 2108 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 2108 may form a portion of a system-on-a-chip (SoC) and be incorporated, along with one or more of the processor 2104, the main memory 2106, and other components of the compute circuitry 2102, into the compute circuitry 2102.

The one or more illustrative data storage devices 2110 may be embodied as any type of devices configured for short-term or long-term storage of data such as, for example, memory devices and circuits, memory cards, hard disk drives, solid-state drives, or other data storage devices. Each data storage device 2110 may include a system partition that stores data and firmware code for the data storage device 2110. Each data storage device 2110 may also include one or more operating system partitions that store data files and executables for operating systems depending on, for example, the type of compute node 2100.

The communication circuitry 2112 may be embodied as any communication circuit, device, or collection thereof, capable of enabling communications over a network between the compute circuitry 2102 and another compute device (e.g., an edge gateway node 2012 of an edge computing system). The communication circuitry 2112 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, etc.) to effect such communication.

The illustrative communication circuitry 2112 includes a network interface controller (NIC) 2120, which may also be referred to as a host fabric interface (HFI). The NIC 2120 may be embodied as one or more add-in-boards, daughter cards, network interface cards, controller chips, chipsets, or other devices that may be used by the compute node 2100 to connect with another compute device (e.g., an edge gateway node 2012). In some examples, the NIC 2120 may be embodied as part of a system-on-a-chip (SoC) that includes one or more processors, or included on a multichip package that also contains one or more processors. In some examples, the NIC 2120 may include a local processor (not shown) and/or a local memory (not shown) that are both local to the NIC 2120. In such examples, the local processor of the NIC 2120 may be capable of performing one or more of the functions of the compute circuitry 2102 described herein. Additionally or alternatively, in such examples, the local memory of the NIC 2120 may be integrated into one or more components of the client compute node at the board level, socket level, chip level, and/or other levels.

Additionally, in some examples, each compute node 2100 may include one or more peripheral devices 2114. Such peripheral devices 2114 may include any type of peripheral device found in a compute device or server such as audio input devices, a display, other input/output devices, interface devices, and/or other peripheral devices, depending on the particular type of the compute node 2100. In further examples, the compute node 2100 may be embodied by a respective edge compute node in an edge computing system (e.g., client compute node 2002, edge gateway node 2012, edge aggregation node 2022) or like forms of appliances, computers, subsystems, circuitry, or other components.

In a more detailed example, FIG. 21B illustrates a block diagram of an example of components that may be present in an edge computing node 2150 for implementing the techniques (e.g., operations, processes, methods, and methodologies) described herein. The edge computing node 2150 may include any combinations of the components referenced above, and it may include any device usable with an edge communication network or a combination of such networks. The components may be implemented as ICs, portions thereof, discrete electronic devices, or other modules, logic, hardware, software, firmware, or a combination thereof adapted in the edge computing node 2150, or as components otherwise incorporated within a chassis of a larger system. Further, to support the security examples provided herein, a hardware RoT (e.g., provided according to a DICE architecture) may be implemented in each IP block of the edge computing node 2150 such that any IP Block could boot into a mode where a RoT identity could be generated that may attest its identity and its current booted firmware to another IP Block or to an external entity.

The edge computing node 2150 may include processing circuitry in the form of a processor 2152, which may be a microprocessor, a multi-core processor, a multithreaded processor, an ultra-low voltage processor, an embedded processor, or other known processing elements. The processor 2152 may be a part of a system on a chip (SoC) in which the processor 2152 and other components are formed into a single integrated circuit, or a single package, such as the Edison™ or Galileo™ SoC boards from Intel Corporation, Santa Clara, California. As an example, the processor 2152 may include an Intel® Architecture Core™ based processor, such as a Quark™, an Atom™, a Xeon™ an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc.

The processor 2152 may communicate with a system memory 2154 over an interconnect 2156 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 2158 may also couple to the processor 2152 via the interconnect 2156. In an example, the storage 2158 may be implemented via a solid-state disk drive (SSDD). A “memory device” or “storage medium” as used herein may encompass any combination of volatile or non-volatile memory or storage—and thus, may include the system memory 2156, the storage 2158, cache on the processor 2152, among other examples. Other devices that may be used for the storage 2158 include flash memory cards, such as SD cards, microSD cards, XD picture cards, and the like, and USB flash drives.

The terms “memory device”, “storage device”, “machine-readable medium”, “machine-readable storage”, “computer-readable storage”, and “computer-readable medium” are used interchangeably in this document. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto-resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 2158 may be on-die memory or registers associated with the processor 2152. However, in some examples, the storage 2158 may be implemented using a micro hard disk drive (HDD). Further, any number of new technologies may be used for the storage 2158 in addition to, or instead of, the technologies described, such resistance change memories, phase change memories, holographic memories, or chemical memories, among others.

The components may communicate over the interconnect 2156. The interconnect 2156 may include any number of technologies, including industry standard architecture (ISA), extended ISA (EISA), peripheral component interconnect (PCI), peripheral component interconnect extended (PCIx), PCI express (PCIe), NVLink, or any number of other technologies. The interconnect 2156 may be a proprietary bus, for example, used in an SoC based system. Other bus systems may be included, such as an I2C interface, an SPI interface, point to point interfaces, and a power bus, among others.

The interconnect 2156 may couple the processor 2152 to a transceiver 2166, for communications with the connected edge devices 2162. The transceiver 2166 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2162. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 2166 (or multiple transceivers) may communicate using multiple standards or radios for communications at a different range. For example, the edge computing node 2150 may communicate with close devices, e.g., within about 10 meters, using a local transceiver based on BLE, or another low power radio, to save power. More distant connected edge devices 2162, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee.

A wireless network transceiver 2166 (e.g., a radio transceiver) may be included to communicate with devices or services in the edge cloud 2190 via local or wide area network protocols. The wireless network transceiver 2166 may be an LPWA transceiver that follows the IEEE 802.15.4, or IEEE 802.15.4g standards, among others. The edge computing node 2150 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 2166, as described herein. For example, the transceiver 2166 may include a cellular transceiver that uses spread spectrum (SPA/SAS) communications for implementing high-speed communications. Further, any number of other protocols may be used, such as Wi-Fi® networks for medium speed communications and provision of network communications. The transceiver 2166 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 2168 may be included to provide a wired communication to nodes of the edge cloud 2190 or to other devices, such as the connected edge devices 2162 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 2168 may be included to enable connecting to a second network, for example, a first NIC 2168 providing communications to the cloud over Ethernet, and a second NIC 2168 providing communications to other devices over another type of network.

Given the variety of types of applicable communications from the device to another component or network, applicable communications circuitry used by the device may include or be embodied by any one or more of components 2164, 2166, 2168, or 2170. Accordingly, in various examples, applicable means for communicating (e.g., receiving, transmitting, etc.) may be embodied by such communications circuitry.

The edge computing node 2150 may include or be coupled to acceleration circuitry 2164, which may be embodied by one or more AI accelerators, a neural compute stick, neuromorphic hardware, an FPGA, an arrangement of graphical processing units (GPUs), infrastructure processing units (IPUs), one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 2156 may couple the processor 2152 to a sensor hub or external interface 2170 that is used to connect additional devices or subsystems. The devices may include sensors 2172, such as accelerometers, level sensors, flow sensors, optical light sensors, camera sensors, temperature sensors, a global positioning system (GPS) sensors, pressure sensors, barometric pressure sensors, and the like. The hub or interface 2170 further may be used to connect the edge computing node 2150 to actuators 2174, such as power switches, valve actuators, an audible sound generator, a visual warning device, and the like.

In some optional examples, various input/output (I/O) devices may be present within or connected to, the edge computing node 2150. For example, a display or other output device 2184 may be included to show information, such as sensor readings or actuator position. An input device 2186, such as a touch screen or keypad may be included to accept input. An output device 2184 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 2150.

A battery 2176 may power the edge computing node 2150, although, in examples in which the edge computing node 2150 is mounted in a fixed location, it may have a power supply coupled to an electrical grid. The battery 2176 may be a lithium ion battery, or a metal-air battery, such as a zinc-air battery, an aluminum-air battery, a lithium-air battery, and the like.

A battery monitor/charger 2178 may be included in the edge computing node 2150 to track the state of charge (SoCh) of the battery 2176. The battery monitor/charger 2178 may be used to monitor other parameters of the battery 2176 to provide failure predictions, such as the state of health (SoH) and the state of function (SoF) of the battery 2176. The battery monitor/charger 2178 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 2178 may communicate the information on the battery 2176 to the processor 2152 over the interconnect 2156. The battery monitor/charger 2178 may also include an analog-to-digital (ADC) converter that enables the processor 2152 to directly monitor the voltage of the battery 2176 or the current flow from the battery 2176. The battery parameters may be used to determine actions that the edge computing node 2150 may perform, such as transmission frequency, mesh network operation, sensing frequency, and the like.

A power block 2180, or other power supply coupled to a grid, may be coupled with the battery monitor/charger 2178 to charge the battery 2176. In some examples, the power block 2180 may be replaced with a wireless power receiver to obtain the power wirelessly, for example, through a loop antenna in the edge computing node 2150. A wireless battery charging circuit, such as an LTC4020 chip from Linear Technologies of Milpitas, California, among others, may be included in the battery monitor/charger 2178. The specific charging circuits may be selected based on the size of the battery 2176, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2158 may include instructions 2182 in the form of software, firmware, or hardware commands to implement the techniques described herein. Although such instructions 2182 are shown as code blocks included in the memory 2154 and the storage 2158, it may be understood that any of the code blocks may be replaced with hardwired circuits, for example, built into an application specific integrated circuit (ASIC).

In an example, the instructions 2182 provided via the memory 2154, the storage 2158, or the processor 2152 may be embodied as a non-transitory, machine-readable medium 2160 including code to direct the processor 2152 to perform electronic operations in the edge computing node 2150. The processor 2152 may access the non-transitory, machine-readable medium 2160 over the interconnect 2156. For instance, the non-transitory, machine-readable medium 2160 may be embodied by devices described for the storage 2158 or may include specific storage units such as optical disks, flash drives, or any number of other hardware devices. The non-transitory, machine-readable medium 2160 may include instructions to direct the processor 2152 to perform a specific sequence or flow of actions, for example, as described with respect to the flowchart(s) and block diagram(s) of operations and functionality depicted above. As used herein, the terms “machine-readable medium” and “computer-readable medium” are interchangeable.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Each of the block diagrams of FIGS. 21A and 21B are intended to depict a high-level view of components of a device, subsystem, or arrangement of an edge computing node. However, it will be understood that some of the components shown may be omitted, additional components may be present, and a different arrangement of the components shown may occur in other implementations.

FIG. 2210 illustrates an example software distribution platform 2205 to distribute software, such as the example computer readable instructions 2182 of FIG. 21B, to one or more devices, such as example processor platform(s) 2210 and/or other example connected edge devices or systems discussed herein. The example software distribution platform 2205 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 2205). Example connected edge devices may operate in commercial and/or home automation environments. In some examples, a third party is a developer, a seller, and/or a licensor of software such as the example computer readable instructions 2182 of FIG. 21B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

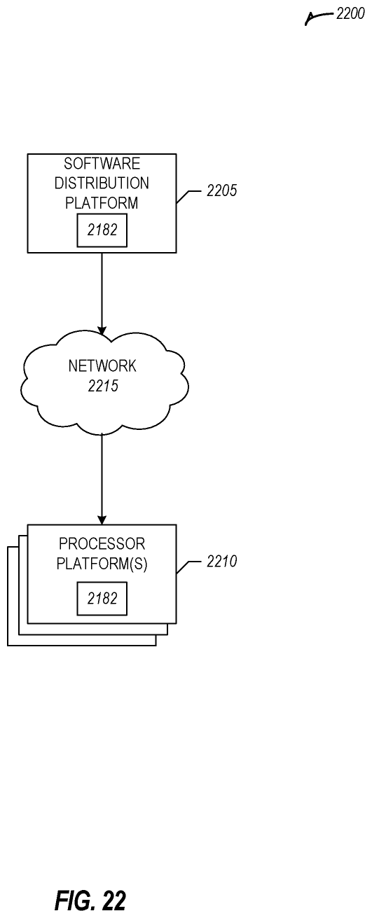

In the illustrated example of FIG. 22, the software distribution platform 2205 includes one or more servers and one or more storage devices that store the computer readable instructions 2182. The one or more servers of the example software distribution platform 2205 are in communication with a network 2215, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 2182 from the software distribution platform 2205. For example, the software, which may correspond to example computer readable instructions, may be downloaded to the example processor platform(s), which is/are to execute the computer readable instructions 2182. In some examples, one or more servers of the software distribution platform 2205 are communicatively connected to one or more security domains and/or security devices through which requests and transmissions of the example computer readable instructions 2182 must pass. In some examples, one or more servers of the software distribution platform 2205 periodically offer, transmit, and/or force updates to the software (e.g., the example computer readable instructions 2182 of FIG. 21B) to ensure improvements, patches, updates, etc. are distributed and applied to the software at the end user devices.

In the illustrated example of FIG. 22, the computer readable instructions 2182 are stored on storage devices of the software distribution platform 2205 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 2182 stored in the software distribution platform 2205 are in a first format when transmitted to the example processor platform(s) 2210. In some examples, the first format is an executable binary in which particular types of the processor platform(s) 2210 can execute. However, in some examples, the first format is uncompiled code that requires one or more preparation tasks to transform the first format to a second format to enable execution on the example processor platform(s) 2210. For instance, the receiving processor platform(s) 2200 may need to compile the computer readable instructions 2182 in the first format to generate executable code in a second format that is capable of being executed on the processor platform(s) 2210. In still other examples, the first format is interpreted code that, upon reaching the processor platform(s) 2210, is interpreted by an interpreter to facilitate execution of instructions.

In the examples above, many references were provided to LEO satellites and constellations. However, it will be understood that the examples above are also relevant to many forms of in-orbit satellites and constellations, stationary (geosynchronous) orbit satellites and constellations, and other high altitude communication platforms such as balloons, drones, airships and blimps, etc. Thus, it will be understood that the techniques discussed for LEO networks are also applicable to many other network settings.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations that involve terrestrial network connectivity (where available) to increase network bandwidth/throughput and to support additional edge services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

What is claimed is:

1. A computing system, comprising:
processing circuitry; and
a memory device including instructions embodied thereon, wherein the instructions, which when executed by the processing circuitry, configure the processing circuitry to perform operations that:
obtain orbital position data for at least one satellite vehicle (SV), the at least one SV capable to perform supplemental coverage from space (SCS) network communications;
determine operational parameters to mitigate terrestrial interference of the SCS network communications on a terrestrial network located in a two-dimensional or three-dimensional space corresponding to a geographic area, the space identified based on the orbital position data; and
generate data to modify operation of the SCS network communications from the at least one SV to the geographic area, based on the determined operational parameters.

2. The computing system of claim 1, wherein the data to modify operation of the SCS network communications to the geographic area, includes to schedule mitigation of the SCS network communications in the at least one SV before reaching an orbital position associated with coverage of the geographic area.

3. The computing system of claim 1, wherein the instructions further configure the processing circuitry to perform operations that:
identify the terrestrial interference of the SCS network communications with a model, based on multiple measurements corresponding to the at least one SV or the terrestrial network.

4. The computing system of claim 3, wherein the model comprises a learning model that is generated based on earth-centric or space-centric measurement evaluation consistent with an SCS Zone, the SCS zone corresponding to the geographic area or a transposed two-dimensional or three-dimensional space.

5. The computing system of claim 3, wherein to identify the terrestrial interference is based on a detected or predicted condition identified by the model.

6. The computing system of claim 1, wherein the terrestrial interference is determined based on at least one measurement of radio interference observed between the SCS network communications and the terrestrial network.

7. The computing system of claim 6, wherein the at least one measurement of the radio interference is based on communications with an earth station of the terrestrial network.

8. The computing system of claim 1, wherein the terrestrial interference is determined based on at least one prediction of co-channel interference to occur between the at least one SV and the terrestrial network with the SCS network communications.

9. The computing system of claim 8, wherein to modify operation of the SCS network communications at a respective SV includes to:
change transmit power;
change reception power;
change use to at least one different frequency;
change use to at least one different antenna;
change use to at least one different ground station; or
perform at least one additional orbit maneuver of the respective SV.

10. The computing system of claim 1, wherein the SV is a low-Earth orbit (LEO) SV, wherein the terrestrial network is a 4G Long Term Evolution (LTE) or 5G Fifth Generation network operating in at least one regulated frequency band according to a 3GPP standard, and wherein the SCS network communications are to operate in the at least one regulated frequency band.

11. A method, comprising a plurality of operations executed with a processor and memory of a device, to dynamically mitigate interference in a supplemental coverage from space (SCS) network arrangement, comprising:
obtaining orbital position data for at least one satellite vehicle (SV), the at least one SV capable to perform supplemental coverage from space (SCS) network communications;
determining operational parameters to mitigate terrestrial interference of the SCS network communications on a terrestrial network located in a two-dimensional or three-dimensional space corresponding to a geographic area, the geographic area identified based on the orbital position data; and
modifying operation of the SCS network communications from the at least one SV to the geographic area, based on the determined operational parameters.

12. The method of claim 11, wherein modifying operation of the SCS network communications to the geographic area, includes to schedule mitigation of the SCS network communications in the at least one SV before reaching an orbital position associated with coverage of the geographic area.

13. The method of claim 11, further comprising:
identifying the terrestrial interference of the SCS network communications using a model, the identifying to be performed based on multiple measurements corresponding to the at least one SV or the terrestrial network.

14. The method of claim 13, wherein the model comprises a learning model that is generated based on earth-centric or space-centric measurement evaluation consistent with an SCS Zone, the SCS zone corresponding to the geographic area or a transposed two-dimensional or three-dimensional space.

15. The method of claim 13, wherein to identify the terrestrial interference is based on a detected or predicted condition identified by the model.

16. The method of claim 11, wherein the terrestrial interference is determined based on at least one measurement of radio interference observed between the SCS network communications and the terrestrial network.

17. The method of claim 16, wherein the at least one measurement of the radio interference is based on communications with an earth station of the terrestrial network.

18. The method of claim 11, wherein the terrestrial interference is determined based on at least one prediction of co-channel interference to occur between the at least one SV and the terrestrial network with the SCS network communications.

19. The method of claim 18, wherein to modify operation of the SCS network communications at a respective SV includes to:
change transmit power;
change reception power;
change use to at least one different frequency;
change use to at least one different antenna;
change use to at least one different ground station; or
perform at least one additional orbit maneuver of the respective SV.

20. The method of claim 11, wherein the SV is a low-Earth orbit (LEO) SV, wherein the terrestrial network is a 4G Long Term Evolution (LTE) or 5G Fifth Generation network operating in at least one regulated frequency band according to a 3GPP standard, and wherein the SCS network communications are to operate in the at least one regulated frequency band.
